(19) United States
(12) Patent Application Publication
(10) Pub. No.: US 2013/0049405 A1
(43) Pub. Date: Feb. 28, 2013

(54) VEHICLE-BODY STRUCTURE OF VEHICLE AND MANUFACTURING METHOD OF THE SAME

(71) Applicants: Osamu KUROGI, Hiroshima (JP); Tsuyoshi SUGIHARA, Hiroshima (JP); Kohya NAKAGAWA, Hiroshima (JP); Kuniaki NAGAO, Hiroshima (JP); Sakayu TERADA, Hiroshima (JP); Miho KOWAKI, Hiroshima (JP); Akira IYOSHI, Hiroshima (JP); Shigeaki WATANABE, Hiroshima (JP)

(72) Inventors: Osamu KUROGI, Hiroshima (JP); Tsuyoshi SUGIHARA, Hiroshima (JP); Kohya NAKAGAWA, Hiroshima (JP); Kuniaki NAGAO, Hiroshima (JP); Sakayu TERADA, Hiroshima (JP); Miho KOWAKI, Hiroshima (JP); Akira IYOSHI, Hiroshima (JP); Shigeaki WATANABE, Hiroshima (JP)

(73) Assignee: MAZDA MOTOR CORPORATION, Hiroshima (JP)

(21) Appl. No.: 13/600,070

(22) Filed: Aug. 30, 2012

(30) Foreign Application Priority Data
Aug. 31, 2011 (JP) 2011-189059

(51) Int. Cl. B62D 21/00; B62D 65/00

(52) U.S. Cl. 296/203.01; 29/897.2

(57) ABSTRACT

In a vehicle-body structure of a vehicle which comprises a frame comprised of vehicle-body forming members forming a closed-section portion, a reinforcing member provided in the closed-section portion and joined to the frame, and another vehicle-body forming member joined to an outer face of the frame, which is different from the vehicle-body forming members of the frame, a joint portion of the frame and the reinforcing member includes a rigid joint portion where the frame and the reinforcing member are joined with a direct contact thereof and a flexible joint portion where the frame and the reinforcing member are joined via a damping member provided therebetween, and the joint portion is provided at a specified position on an inner face of the frame located in the vicinity of a portion where the forming member is joined to the frame.

### BACKGROUND OF THE INVENTION

The present invention relates to a vehicle-body structure of a vehicle and a manufacturing method of the same.

Vehicles, such as automotive vehicles, are required to increase the rigidity of a vehicle body in order to improve the comfortable ride and the safety. Japanese Utility Model Laid-Open publication Nos. 59-182472 and 60-097673, for example, disclose structures for increasing the rigidity in which a reinforcing member is provided in a closed-section portion formed by a vehicle-body forming member.

The first one of the above-described patent publications discloses the structure in which the bulkhead is arranged in a bamboo-joint shape in the closed-section portion of the side sill formed by the side sill outer and the side sill inner, and the flange portions formed at its periphery are joined to the inner faces of the side sill outer and the side sill inner by both spot welding and an adhesive agent.

The second one of the above-described patent publications discloses the structure in which the bulkhead is arranged in the bamboo-joint shape in the closed-section portion of the front suspension member formed by the upper member and the lower member, and the flange portions formed at its periphery are joined to the inner face of the upper member by an adhesive agent for structure.

According to the structures disclosed in the above-described patent publications, however, there is a concern that while improvement of the rigidity is achieved, vibrations occurring at various portions of the vehicle may not be effectively restrained from being transmitted to the inside portion of the vehicle compartment in some cases depending on arrangement positions, shapes, and the like. Therefore, further improvement of the vehicle-body structure has been required in order to properly restrain vibration transmission to passengers for improving the comfortable ride and reducing noises.

### SUMMARY OF THE INVENTION

An object of the present invention is to provide a vehicle-body structure of a vehicle or a manufacturing method of the same which can properly restrain the vibration transmission, thereby improve the comfortable ride and reduce noises of the vehicle, ensuring the sufficient rigidity of the vehicle-body structure.

According to the present invention, there is provided a vehicle-body structure of a vehicle, comprising a frame comprised of at least one vehicle-body forming member forming a closed-section portion, a reinforcing member provided in the closed-section portion of the frame and joined to the frame, and another vehicle-body forming member joined to an outer face of the frame, which is different from the at least one vehicle-body forming member, wherein a joint portion of the frame and the reinforcing member includes a rigid joint portion where the frame and the reinforcing member are joined with a direct contact thereof and a flexible joint portion where the frame and the reinforcing member are joined via a damping member provided therebetween, and the joint portion is provided at a specified position on an inner face of the frame which is located in the vicinity of a portion where the above-described other vehicle-body forming member is joined to the frame.

According to the present invention, since the reinforcing member is provided in the closed-section portion of the frame formed by a single vehicle-body forming member made in a hollow-tube shape, for example, or plural vehicle-body forming members joined together, the rigidity of the frame and a specified portion of the vehicle body formed by the frame can be improved, so that any deformation of that portion, collapse of the closed-section portion, or the like can be properly restrained. In this case, since the joint portion of the frame and the reinforcing member includes the rigid joint portion by using welding, bolt fastening or the like as well as the flexible joint portion by using the damping member, the frame and the reinforcing member can be joined firmly with the rigid joint portion, thereby improving the rigidity, and vibrations of the frame can be properly reduced by the damping member provided at the flexible joint portion. Thereby, the above-described vibration transmission can be properly restrained, ensuring the sufficient rigidity of the vehicle-body structure, so that the comfortable ride can be improved and the noises can be reduced. Herein, the present invention may not require any additional member to restrain the vibration transmission, so that the above-described effects can be advantageously provided, avoiding any improper weight increase of the vehicle body or the like. Further, since the joint portion of the frame and the reinforcing member is provided at the specified position on the inner face of the frame which is located in the vicinity of the portion where the above-described other vehicle-body forming member is joined to the frame, vibrations inputted to the frame from the other vehicle-body forming member can be effectively reduced, so that the above-described effects can be obtained more properly.

According to an embodiment of the present invention, the damping member is a viscoelastic member having physical properties which fall within a range enclosed by six coordinate points: (1, 0.4), (2, 0.2), (10, 0.1), (1000, 0.1), (2000, 0.2) and (10000, 0.4) in an X-Y coordinate system with X axis of the storage modulus and Y axis of the loss factor, or a range exceeding the loss factor of 0.4. Thereby, since the viscoelastic member is used as the damping member and the storage modulus and the loss factor as its physical properties are specified as any values falling within the specified range which has been confirmed as an effective range capable of providing the vibration-damping effect, the above-described damping effect of vibrations of the vehicle-body forming member(s) according to the present invention can be surely provided.

According to another embodiment of the present invention, the reinforcing member is a bulkhead having at least one flange portion provided at a periphery thereof, and the joint portion is provided at the flange portion. Thereby, the above-described effects of rigidity improvement and vibration damping by the joint portions can be surely provided as an appropriate concrete structure.

According to another embodiment of the present invention, the bulkhead comprises two sheets of partition face portion which partition the closed-section portion of the frame and a connection portion which connects the two sheets of partition face portion. Thereby, the rigidity-improvement effect by the bulkhead can be provided over a properly-wide range of the frame forming the closed-section portion, and the number of parts can be reduced by half, compared with a case in which a pair of bulkheads are arranged at two adjacent positions in the closed-section portion respectively, so that parts control or assembling efficiency can be improved.

According to another embodiment of the present invention, the rigid joint portion and the flexible joint portion are provided at one flange portion of the bulkhead. Thereby, the joint strength of the bulkhead to the frame can be ensured by the joint portion of the flange portion, and the vibration-damping effect can be provided.

According to another embodiment of the present invention, the closed-section portion of the frame is comprised of two vehicle-body forming members. Thereby, the above-described effects can be provided at a structure in which the closed-section portion of the frame is formed by the two vehicle-body forming members.

According to another aspect of the present invention, there is provided a manufacturing method of a vehicle-body structure of a vehicle which comprises a frame comprised of at least one vehicle-body forming member forming a closed-section portion, a reinforcing member provided in the closed-section portion of the frame and joined to the frame, and another vehicle-body forming member joined to an outer face of the frame, which is different from the at least one vehicle-body forming member, the method comprising a step of joining the frame and the reinforcing member at a specified position on an inner face of the frame which is located in the vicinity of a portion where the above-described other vehicle-body forming member is joined to the frame, wherein the joining step includes a rigid joining step of joining the frame and the reinforcing member with a direct contact thereof and a flexible joining step of joining the frame and the reinforcing member via a damping member provided therebetween. A vehicle-body structure of a vehicle manufactured by this method can provide the same effects described above for the present invention.

Other features, aspects, and advantages of the present invention will become apparent from the following description which refers to the accompanying drawings.

### BRIEF DESCRIPTION OF THE DRAWINGS

FIGS. 1A and 1B are diagrams showing models used for a simulation of an embodiment of the present invention.

FIG. 2 is a graph showing characteristics of the inertance relative to the frequency from the simulation.

FIG. 3 is a mode-damping-ratio variation characteristic graph for the loss factor and the storage modulus of a damping member from the simulation.

FIG. 4 is a graph showing relationships of the loss factor and the storage modulus when a damping effect is substantially obtained in a case of using a viscoelastic member as the damping member.

FIG. 5 is a view showing a front portion of a vehicle body to which first and second embodiments of the present invention are applied.

FIG. 6 is a sectional view taken along line Y6-Y6 of FIG. 5.

FIGS. 7A and 7B are sectional views taken along lines Y7a-Y7a and Y7b-Y7b of FIG. 6, respectively.

FIG. 8 is a perspective view showing a bulkhead as a reinforcing member according to the first embodiment of the present invention.

FIG. 9 is a sectional view taken along line Y9-Y9 of FIG. 5.

FIGS. 10A and 10B are sectional views taken along lines Y10a-Y10a and Y10b-Y10b of FIG. 9, respectively.

FIG. 11 is a perspective view showing a bulkhead as the reinforcing member according to the second embodiment of the present invention.

FIG. 12 is a view showing a front portion of a vehicle compartment to which a vehicle-body structure of a vehicle according to a third embodiment of the present invention is applied.

FIG. 13 is a sectional view taken along line Y13-Y13 of FIG. 12.

FIG. 14 is a sectional view taken along line Y14-Y14 of FIG. 13.

FIG. 15 is a perspective view showing a bulkhead as the reinforcing member according to the third embodiment of the present invention.

FIG. 16 is a view showing a side portion and a bottom portion of the vehicle compartment to which a vehicle-body structure of a vehicle according to fourth through eighth embodiments of the present invention is applied.

FIG. 17 is a sectional view taken along line Y17-Y17 of FIG. 16.

FIG. 18 is a sectional view taken along line Y18-Y18 of FIG. 17.

FIG. 19 is a perspective view showing a bulkhead as the reinforcing member according to the fourth embodiment of the present invention.

FIG. 20 is a sectional view taken along line Y20-Y20 of FIG. 16.

FIG. 21 is a sectional view taken along line Y21-Y21 of FIG. 20.

FIG. 22 is a perspective view showing a bulkhead as the reinforcing member according to the fifth embodiment of the present invention.

FIG. 23 is an enlarged view of a first major part of FIG. 16.

FIG. 24 is a sectional view taken along line Y24-Y24 of FIG. 23.

FIG. 25 is a perspective view showing a bulkhead as the reinforcing member according to the sixth embodiment of the present invention.

FIG. 26 is an enlarged view of a second major part of FIG. 16.

FIG. 27 is a sectional view taken along line Y27-Y27 of FIG. 26.

FIGS. 28A and 28B are sectional views taken along lines Y28a-Y28a and Y28b-Y28b of FIG. 27, respectively.

FIG. 29 is a perspective view showing a bulkhead as a first reinforcing member according to the seventh embodiment of the present invention.

FIG. 30 is a perspective view showing a bulkhead as a second reinforcing member according to the seventh embodiment of the present invention.

FIG. 31 is an enlarged view of a third major part of FIG. 16.

FIG. 32 is a sectional view taken along line Y32-Y32 of FIG. 31.

FIG. 33 is a sectional view taken along line Y33-Y33 of FIG. 32.

FIG. 34 is a perspective view showing a bulkhead as the reinforcing member according to the eighth embodiment of the present invention.

FIG. 35 is a view showing a rear portion of the vehicle body to which a vehicle-body structure of a vehicle according to ninth and tenth embodiments of the present invention is applied.

FIG. 36 is an enlarged view of a major part of FIG. 35.

FIG. 37 is a sectional view taken along line Y37-Y37 of FIG. 36.

FIG. 38 is a sectional view taken along line Y38-Y38 of FIG. 37.

FIG. 39 is a perspective view showing a bulkhead as the reinforcing member according to the ninth embodiment of the present invention.

FIG. 40 is an enlarged view of a major part of FIG. 35.

FIG. 41 is a sectional view taken along line Y41-Y41 of FIG. 40.

FIG. 42 is a sectional view taken along line Y42-Y42 of FIG. 41.

FIG. 43 is a perspective view showing a bulkhead as the reinforcing member according to the tenth embodiment of the present invention.

FIG. 44 is a view showing a side portion of the vehicle body to which a vehicle-body structure of a vehicle according to an eleventh embodiment of the present invention is applied.

FIG. 45 is an enlarged view of a major part of FIG. 44.

FIG. 46 is a sectional view taken along line Y46-Y46 of FIG. 45.

FIG. 47 is a sectional view taken along line Y47-Y47 of FIG. 46.

FIG. 48 is a perspective view showing a bulkhead as the reinforcing member according to the eleventh embodiment of the present invention.

FIG. 49 is a view showing a side portion of a front side of the vehicle body to which a vehicle-body structure of a vehicle according to a twelfth embodiment of the present invention is applied.

FIG. 50 is an elevational view of a major part of FIG. 49, when viewed along an arrow Y50.

FIG. 51 is a sectional view taken along line Y51-Y51 of FIG. 50.

FIG. 52 is a sectional view taken along line Y52-Y52 of FIG. 50.

FIG. 53 is a perspective view showing a bulkhead as the reinforcing member according to the twelfth embodiment of the present invention.

### DETAILED DESCRIPTION OF THE INVENTION

Hereinafter, preferred embodiments of the present invention will be described referring to the accompanying drawings.

At first, results of simulation conducted to the structures specified in claims of the present invention will be described prior to descriptions of specific applicable structures to a vehicle body.

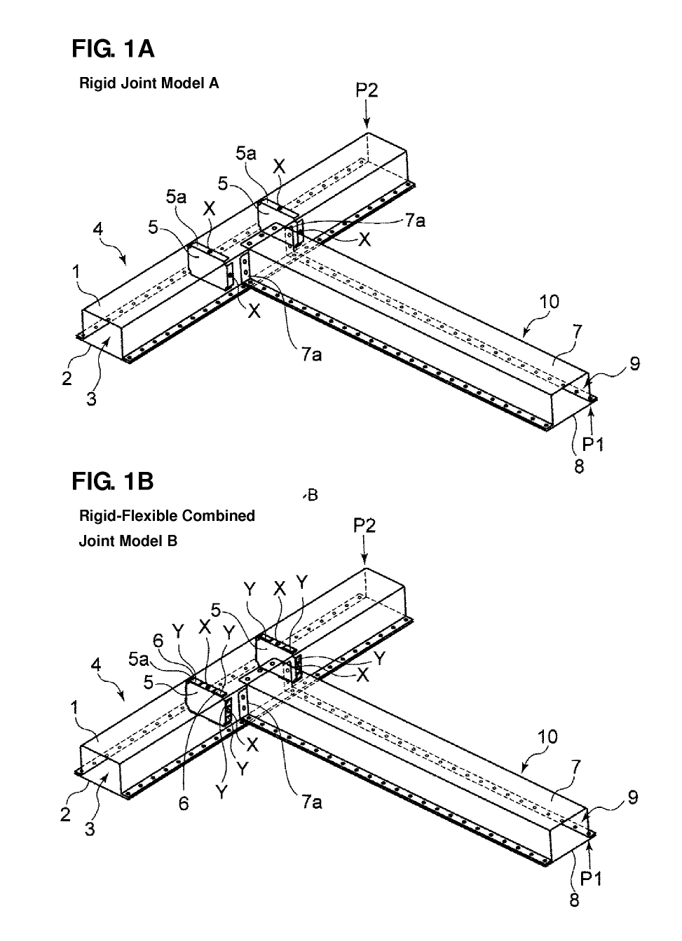

FIGS. 1A and 1B are diagrams showing models used for a simulation of an embodiment of the present invention, and show a rigid joint model A and a rigid-flexible combined joint model B which have been used for the simulation, respectively. In each model, a first member 1 having a U-shaped section and a second member 2 having a flat-plate shape are used as vehicle-body forming members, which form a hollow frame 4 having a closed-section portion 3 with a rectangular section by joining both-side end portions of the second member 2 to flange portions formed at both sides of the first member 1.

Further, a hollow frame 10 having a closed-section portion 9 with a rectangular section which is formed by joining both-side end portions of a fourth member 8 having a flat-plate shape to flange portions formed at both sides of a third member 7 having a U-shaped section is joined to an outer face of the hollow frame 4 substantially in perpendicular. The hollow frame 10 is joined to the outer face of the hollow frame 4 via flange portions 7a formed at one-side ends of the third member 7 of the hollow frame 10 in its longitudinal direction.

Moreover, two bulkheads 5 are provided in the closed-section portion 3 of the hollow frame 4 as a reinforcing member. The bulkheads 5 are fixed in the hollow frame 4 by joining flange portions 5a formed at its four peripheral sides to inner faces of the first and second members 1, 2, respectively. The two bulkheads 5 are fixed to specified positions on an inner face of the hollow frame 4 which are located in the vicinity of respective portions where the flange portions 7a of the third member 7 of the hollow frame 10 are joined to the hollow frame 4.

In the rigid joint model A shown in FIG. 1A, the flanges 5a . . . 5a of each of the bulkheads 5 are joined to the first and second members 1, 2 at each central portion thereof by spot welding. In the rigid-flexible combined joint model B shown in FIG. 1B, the flanges 5a . . . 5a of each of the bulkheads 5 are joined to the inner faces of the first and second members 1, 2 at each central portion thereof by spot welding and also at each both sides thereof via damping members 6, 6. Herein, the above-described joint portion with the spot welding constitutes a rigid joint portion X and the above-described joint portion with the damping member 6 constitutes a flexible joint portion Y.

Herein, while the model B equipped with both the rigid joint portion X and the flexible joint portion Y has a higher rigidity than the model A equipped with only the rigid joint portion X and therefore there exists a difference in the resonance frequency between the models A, B, in order to compare these models properly by making their resonance frequency uniform, the area of the rigid joint portion X of the model A is set to be slightly larger than that of the rigid joint portion X of the model B. Further, the damping member 6 provided at the flexible joint portion Y is comprised of a viscoelastic member which has the loss factor of 0.4 and the storage modulus of 200 MPa (20° C., 30 Hz).

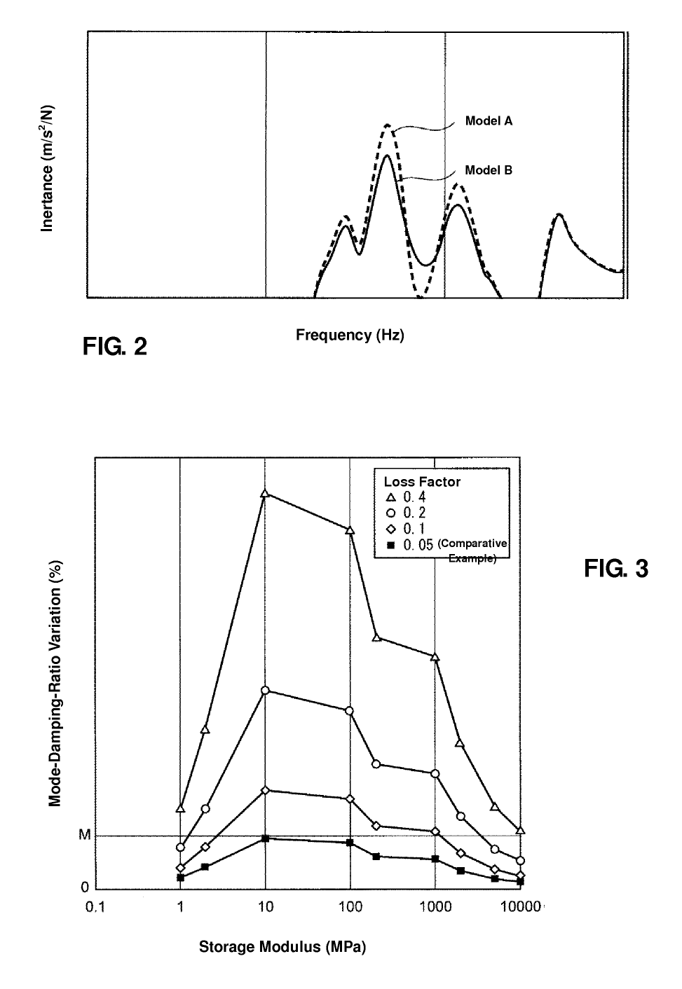

FIG. 2 is a graph showing characteristics of the inertance relative to the frequency from the simulation, which shows simulation results. Herein, in each of the models A, B, a specified corner portion of the closed-section portion 9 at one end of the hollow frame 10 thereof is set as an exciting point P1 and a specified corner portion of the closed-section portion 3 at one end of the hollow frame 4 is set as a responsive point P2. FIG. 2 shows a comparison of the respective inertance at the responsive point P2 (a magnitude of an acceleration amplitude per an exciting force: m/s²/N), in which the model A is shown by a broken line and the model B is shown by a solid line. As apparent from FIG. 2, a peak value of the inertance of the rigid-flexible combined joint model B is lower than that of the rigid joint model A. Accordingly, it is shown that the amount of damping occurring in the process of vibration transmission becomes greater by providing the flexible joint portion Y.

FIG. 3 is a mode-damping-ratio variation characteristic graph for the loss factor and the storage modulus of a damping member from the simulation, which shows simulation results of a mode-damping-ratio variation characteristic for the storage modulus and the loss factor when using plural viscoelastic members having different values of the loss factor as the damping member 6 in the above-described rigid-flexible combined joint model B. Herein, the damping member having the loss factor of 0.05 is a comparative sample, which is an adhesive agent for structure generally used in the vehicle body.

As apparent from this figure, it is shown that the mode-damping-ratio variation in a case of using the viscoelastic member is greater than that in a case of using the general adhesive agent for structure (the loss factor of 0.05) in a whole area of the storage modulus, thereby damping the vibration more easily. In particular, it is shown that the mode-damping-ratio variation becomes greater as the loss factor becomes greater, and that the mode-damping-ratio variation becomes the maximum when the storage modulus is 100 MPa regardless of the value of the loss factor.

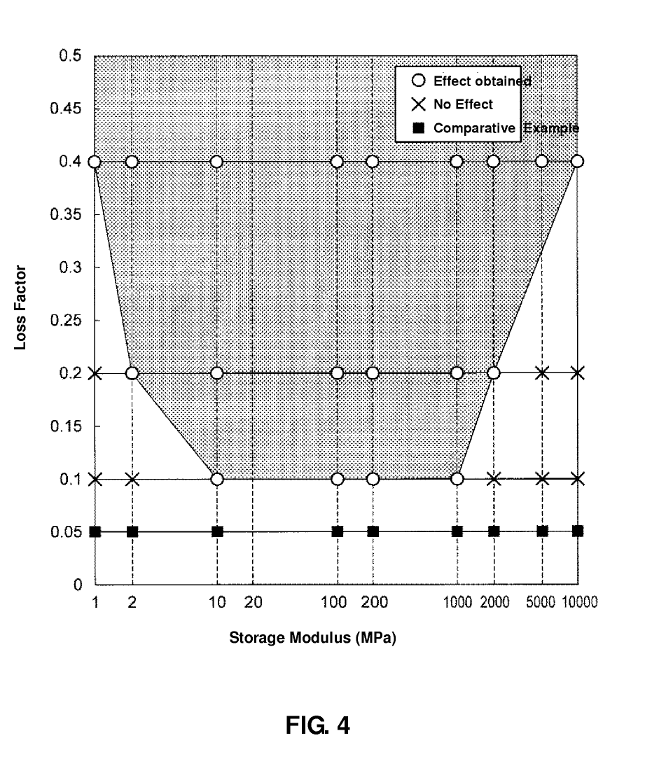

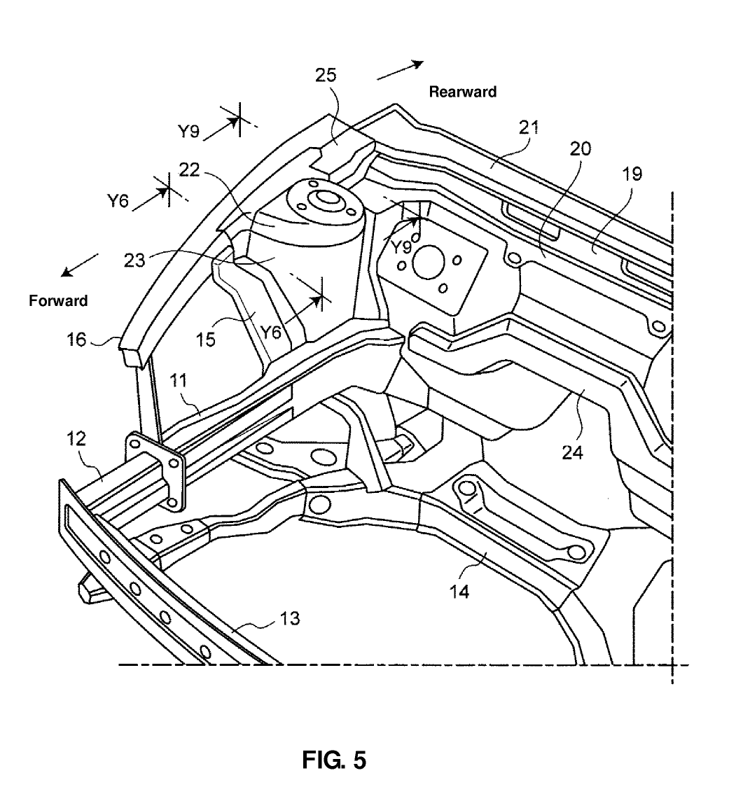

FIG. 4 shows relationships between the loss factor and the storage modulus which can substantially obtain the damping effect in a case in which the viscoelastic member is used as the damping member 6 from the simulation results of FIG. 3. In this figure, it is determined that the effect can be obtained in a case in which the mode-damping-ratio variation is a threshold M or greater which is shown in FIG. 3, while no effect can be obtained in a case in which the mode-damping-ratio variation is less than the threshold M.

Consequently, it has been found out that the damping effect can be obtained in substantially a range enclosed by six coordinate points: (1, 0.4), (2, 0.2), (10, 0.1), (1000, 0.1), (2000, 0.2) and (10000, 0.4) in an X-Y coordinate system with X axis of the storage modulus and Y axis of the loss factor, and a range exceeding the loss factor of 0.4.

Next, preferred embodiments in which the structure of the present invention is applied to the vehicle body will be described.

FIG. 5 is a view showing a front portion of a vehicle body to which first and second embodiments of the present invention are applied. As shown in FIG. 5, there are provided, as members constituting the circumference of an engine room of the front portion of the vehicle body to which the vehicle-body structure according to the first and second embodiments of the present invention is applied, right and left front side frames 11 extending longitudinally, bumper stays 12 extending forward from respective front end portions of the front side frames 11, a bumper reinforcement 13 interconnecting both front end portions of the bumper stays 12 and extending in a vehicle width direction, a suspension cross member 14 extending in the vehicle width direction in back of the bumper reinforcement 13, apron panels 15 forming part of right and left side face portions of the engine room, and apron reinforcements 16 extending longitudinally above the front side frames 11.

A dash upper panel 19 and a dash lower panel 20, which partition an engine room from a vehicle compartment, are provided in back of the engine room. A cowl panel 21 is provided to extend in the vehicle width direction above the dash upper panel 19. Further, a suspension tower, which is formed by a suspension housing upper 22 and a suspension housing lower 22 and to which an upper end portion of a front suspension device (not illustrated) suspending a front wheel (not illustrated) is attached, is provided at each corner portion of a rear portion of the engine room where a side end portion of the dash lower panel 20 and a rear end portion of the apron reinforcement 16 cross each other.

A central portion, in the vehicle width direction, of a lower side of the dash lower panel 20 is cut off upwardly, which forms an inlet portion of a tunnel portion extending longitudinally. A dash lower reinforcement 24 which has substantially a gate shape in an elevational view and substantially a U-shaped section is provided along the inlet portion of the tunnel portion. Moreover, a wiper attaching member 25 is attached above a right-side end portion of the dash upper panel 19.

The vehicle-body structure of a vehicle according to the first embodiment of the present invention is applied to a specified portion of the apron reinforcement 16 which is located in front of the suspension tower in the front portion of the vehicle body above-described front side frame 11 in the front portion of the vehicle body described above. The vehicle-body structure of a vehicle according to the second embodiment of the present invention is applied to a specified portion of the apron reinforcement 16 in back of the suspension tower in the front portion of the vehicle body above-described front side frame 11 in the front portion of the vehicle body described above.

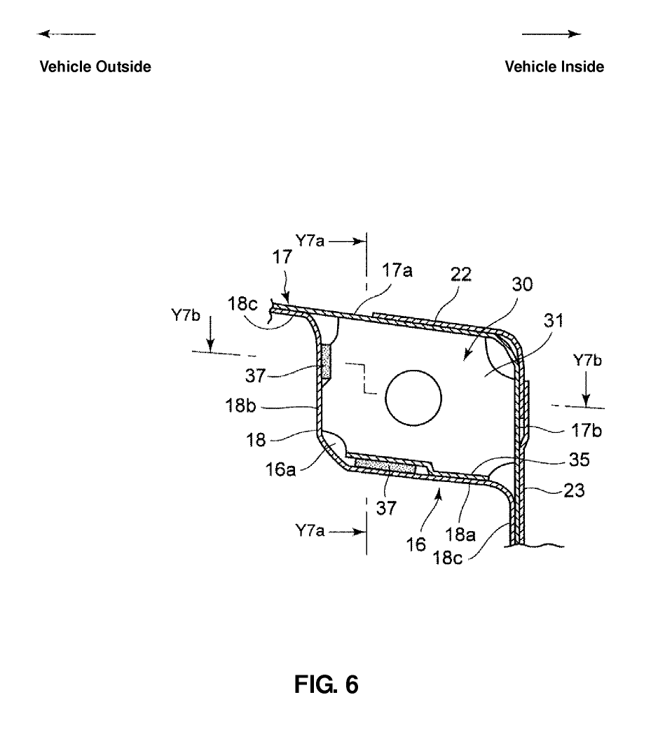

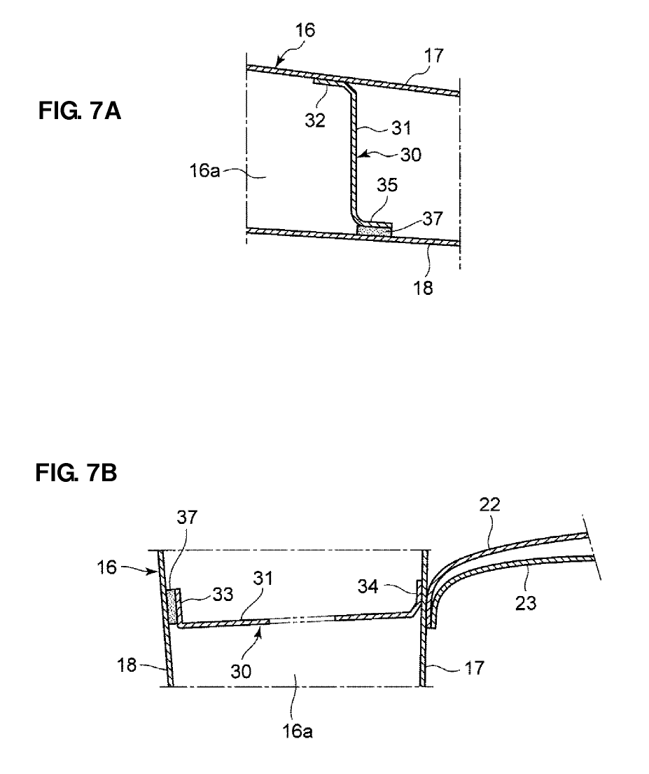

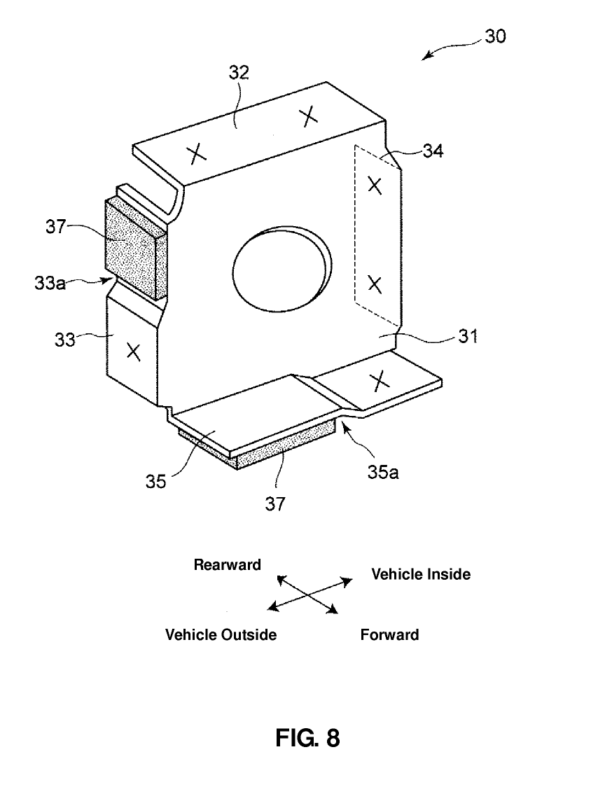

The vehicle-body structure of a vehicle according to the first embodiment of the present invention will be described referring to FIGS. 6 through 8. FIG. 6 is a sectional view taken along line Y6-Y6 of FIG. 5, FIG. 7A is a sectional views taken along line Y7a-Y7a of FIG. 6, FIG. 7B is a sectional views taken along line Y7b-Y7b of FIG. 6, and FIG. 8 is a perspective view showing a bulkhead as a reinforcing member according to the first embodiment of the present invention. In FIG. 8, a state of the bulkhead with a damping member attached thereto is illustrated.

As shown in FIG. 6, the apron reinforcement 16 comprises an apron reinforcement upper 17 forming a vehicle-body upper side thereof and an apron reinforcement lower 18 forming a vehicle-body lower side thereof. The apron reinforcement upper 17 comprises a horizontal face portion 17a and a vertical face portion 17b, and has an L-shaped section. The apron reinforcement lower 18 comprises a horizontal face portion 18a and a vertical face portion 18b, and has an L-shaped section, and also includes flange portions 18c which extend from the horizontal face portion 18a and the vertical face portion 18b respectively. The apron reinforcement 16 has a closed-section portion 16a which is formed by joining the apron reinforcement upper 17 and the apron reinforcement lower 18.

The suspension housing upper 22 is joined to the apron reinforcement upper 17, and the suspension housing lower 23 is joined to a lower end portion of the suspension housing upper 22. Thereby, vibrations are transmitted to the apron reinforcement 16 from the suspension housing 22.

Further, a bulkhead 30 as a reinforcing member is provided in the closed-section portion 16a of the apron reinforcement 16 formed by the apron reinforcement upper 17 and the apron reinforcement lower 18 at a specified position on an inner face of the apron reinforcement 16 which is located in the vicinity of a portion where the suspension housing upper 22 is joined to the apron reinforcement 16.

The bulkhead 30 comprises, as shown in FIG. 8, a partition face portion 31 which partitions the closed-section portion 16a, a first flange portion 32 which is provided at an upper side portion of the partition face portion 31 and extends rearward, a second flange portion 33 which is provided at a vehicle-outside side portion of the partition face portion 31 and extends rearward, a third flange portion 34 which is provided at a vehicle-inside side portion of the partition face portion 31 and extends rearward, and a fourth flange portion 35 which is provided at a lower side portion of the partition face portion 31 and extends forward. A seat portion 33a is formed at the second flange portion 33 in a recess shape so as to accommodate a viscoelastic member 37 therein, which will be described specifically. A seat portion 37a is formed at the fourth flange portion 35 in the recess shape so as to accommodate another viscoelastic member 37 therein.

The first and third flange portions 32, 34 of the bulkhead 30 are joined to the horizontal face portion 17a and the vertical face portion 17b of the apron reinforcement upper 17 respectively by spot welding. The second flange portion 33 of the bulkhead 30 is joined to the vertical face portion 18b of the apron reinforcement lower 18 by spot welding. The viscoelastic member 37 as a vibration damping member which is placed and adheres onto the seat portion 33a of the second flange portion 33 is made adhere to the vertical face portion 18b of the apron reinforcement lower 18. Thus, the second flange portion 33 is joined to the apron reinforcement lower 18 via the viscoelastic member 37.

Further, the fourth flange portion 35 is joined to the horizontal face portion 18a of the apron reinforcement lower 18 by spot welding. The viscoelastic member 37 which is placed and adheres onto the seat portion 35a of the fourth flange portion 35 is made adhere to the horizontal face portion 18a of the apron reinforcement lower 18, whereby the fourth flange portion 35 is joined to the apron reinforcement lower 18 via the viscoelastic member 37.

In a state in which the bulkhead 30 is provided in the closed-section portion 16a formed by the apron reinforcement upper 17 and the apron reinforcement lower 18, the spot-welding joint portions of the bulkhead 30 to the frame of the apron reinforcement 16 comprised of the apron reinforcement upper 17 and the apron reinforcement lower 18 constitute the rigid joint portions. Meanwhile, the joint portions via the viscoelastic members constitute the flexible joint portions. In FIG. 8, the spot-welding portions of the bulkhead 30 are shown by x marks.

Herein, the viscoelastic member 37 having the physical properties which fall within the range enclosed by six coordinate points: (1, 0.4), (2, 0.2), (10, 0.1), (1000, 0.1), (2000, 0.2) and (10000, 0.4) in the X-Y coordinate system with X axis of the storage modulus and Y axis of the loss factor, or the range exceeding the loss factor of 0.4 may be preferably used. A viscoelastic member similar to the above-described viscoelastic member 37 may be preferably used in the other embodiments described below.

While the bulkhead 30 is joined to the inner face of a portion of the apron reinforcement 16 where the suspension housing upper 22 is joined to the apron reinforcement 16 in the above-described embodiment, it may be joined to the inner face of the apron reinforcement 16 near the joint portion of the apron reinforcement 16 to the suspension housing upper 22. Thus, the apron reinforcement 16 and the bulkhead 30 are joined at a specified position on the inner face of the apron reinforcement 16 which is located in the vicinity of the portion where the suspension housing upper 22 is joined to the apron reinforcement 16.

According to the vehicle-body structure of a vehicle according to the first embodiment of the present invention, since the bulkhead 30 is provided in the closed-section portion 16a of the apron reinforcement 16 formed by the apron reinforcement upper 17 and the apron reinforcement lower 18, the rigidity of the above-described frame and the corresponding portion of the vehicle body formed by this frame can be improved, so that any deformation of these members, collapse of the closed-section portion 16a, and the like can be restrained.

In this case, since the first and third flange portions 32, 34 of the bulkhead 30 are rigidly joined to the apron reinforcement upper 17 by spot welding and the second and fourth flange portions 33, 35 are joined to the apron reinforcement lower 18 rigidly by spot welding as well as flexibly via the viscoelastic members 37, the bulkhead 30 can be firmly joined to the apron reinforcement 16 with the rigid joint portions, thereby providing the rigid-improvement effect, and the vibration of the apron reinforcement 16 can be reduced with the flexible joint portion, thereby restraining the vibration transmission to passengers in the vehicle compartment.

Thereby, the above-described vibration transmission can be properly restrained, ensuring the sufficient rigidity of the vehicle-body structure, so that the comfortable ride can be improved and the noises can be reduced. Herein, it may not be required to provide any additional member to restrain the vibration transmission, so that the above-described effects can be advantageously provided, avoiding any improper weight increase of the vehicle body or the like.

Further, since the joint portion of the apron reinforcement 16 and the bulkhead 30 is provided at the specified position on the inner face of the apron reinforcement 16 which is located in the vicinity of the portion where the suspension housing upper 22 of the other vehicle-body forming member which is different from the vehicle-body forming member constituting the apron reinforcement 16 is joined to the apron reinforcement 16, vibrations inputted to the apron reinforcement 16 from the suspension hosing upper 22 can be effectively reduced.

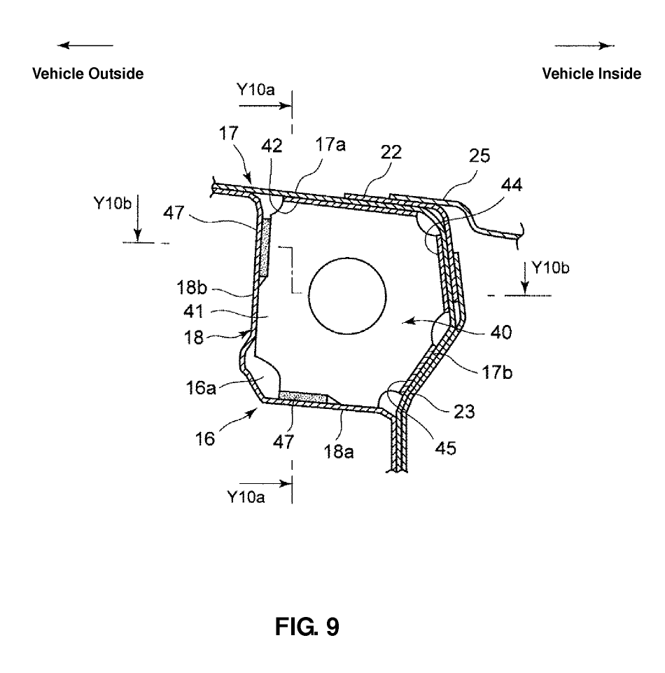

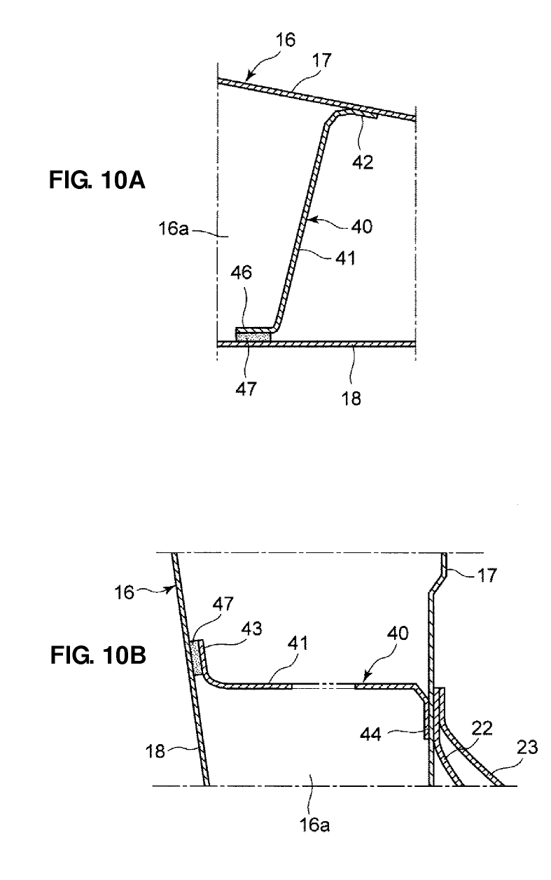

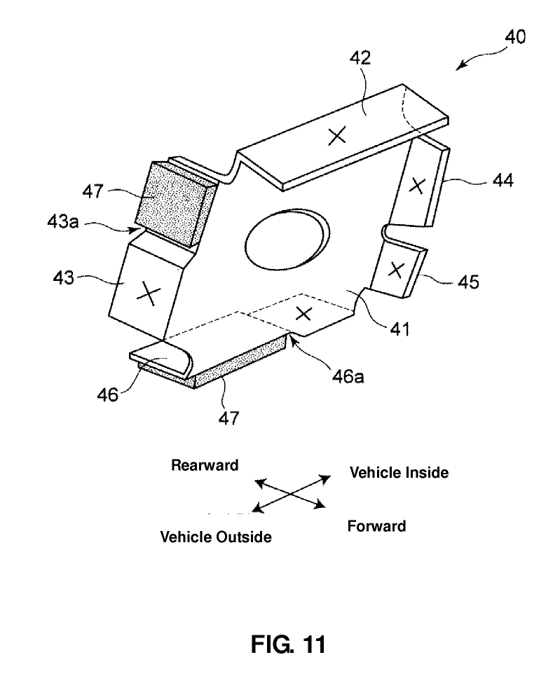

The vehicle-body structure of a vehicle according to the second embodiment of the present invention will be described referring to FIGS. 9 through 11. FIG. 9 is a sectional view taken along line Y9-Y9 of FIG. 5, FIGS. 10A and 10B are sectional views taken along lines Y10a-Y10a and Y10b-Y10b of FIG. 9, and FIG. 11 is a perspective view showing a bulkhead as the reinforcing member according to the second embodiment of the present invention. In FIG. 11, a state of the bulkhead with a damping member attached thereto is illustrated.

As described above, the apron reinforcement 16 is comprised of the apron reinforcement upper 17 which comprises the horizontal face portion 17a and the vertical face portion 17b and has the L-shaped section and the apron reinforcement lower 18 which comprises the horizontal face portion 18a and the vertical face portion 18b, has the L-shaped section, and includes the flange portions 18c extending from the horizontal face portion 18a and the vertical face portion 18b respectively. The apron reinforcement 16 has the closed-section portion 16a which is formed by the apron reinforcement upper 17 and the apron reinforcement lower 18.

As shown in FIG. 9, the suspension housing upper 22 is joined to the apron reinforcement upper 17 and the suspension housing lower 23 is joined to the lower end portion of the suspension housing upper 17 at a specified portion of the outer face of the apron reinforcement 16 which is located in back of the suspension tower as well. Thereby, vibrations are transmitted to the apron reinforcement 16 from the suspension housing upper 22. The wiper attaching member 25 is attached to the upper face of the suspension housing upper 22 as well.

Also, at this portion of the apron reinforcement 16 which is located in back of the suspension tower, a bulkhead 40 as a reinforcing member is provided in the closed-section portion 16a of the apron reinforcement 16 formed by the apron reinforcement upper 17 and the apron reinforcement lower 18 at a specified position which is located in the vicinity of the joint portion of the apron reinforcement 16 to suspension housing upper 22.

The bulkhead 40 comprises, as shown in FIG. 11, a partition face portion 41 which partitions the closed-section portion 16a, a first flange portion 42 which is provided at an upper side portion of the partition face portion 41 and extends forward, a second flange portion 43 which is provided at a vehicle-outside side portion of the partition face portion 41 and extends rearward, third and fourth flange portions 44, 45 which are provided at a vehicle-inside side portion of the partition face portion 41 and extends forward, and a fifth flange portion 46 which is provided at a lower side portion of the partition face portion 41 and extends rearward. A seat portion 43a is formed at the second flange portion 43 in a recess shape so as to accommodate a viscoelastic member 47 therein, which will be described specifically. A seat portion 46a is formed at the fifth flange portion 46 in the recess shape so as to accommodate another viscoelastic member 47 therein.

The first, third and fourth flange portions 42, 44, 45 of the bulkhead 40 are joined to the horizontal face portion 17a and the vertical face portion 17b of the apron reinforcement upper 17 respectively by spot welding. The second flange portion 43 of the bulkhead 40 is joined to the vertical face portion 18b of the apron reinforcement lower 18 by spot welding. The viscoelastic member 37 as the vibration damping member which is placed and adheres onto the seat portion 43a of the second flange portion 43 is made adhere to the vertical face portion 18b of the apron reinforcement lower 18. Thus, the second flange portion 43 is joined to the apron reinforcement lower 18 via the viscoelastic member 47.

Further, the fifth flange portion 46 is joined to the horizontal face portion 18a of the apron reinforcement lower 18 by spot welding. The viscoelastic member 47 which is placed and adheres onto the seat portion 46a of the fifth flange portion 46 is made adhere to the horizontal face portion 18a of the apron reinforcement lower 18, whereby the fifth flange portion 46 is joined to the apron reinforcement lower 18 via the viscoelastic member 47.

In a state in which the bulkhead 40 is provided in the closed-section portion 16a formed by the apron reinforcement upper 17 and the apron reinforcement lower 18, the spot-welding joint portions of the bulkhead 40 to the frame of the apron reinforcement 16 comprised of the apron reinforcement upper 17 and the apron reinforcement lower 18 constitute the rigid joint portions. Meanwhile, the joint portions via the viscoelastic members constitute the flexible joint portions. In FIG. 11, the spot-welding portions of the bulkhead 40 are shown by x marks.

While the bulkhead 40 is joined to the inner face of a portion of the apron reinforcement 16 where the suspension housing upper 22 is joined to the apron reinforcement 16 in the above-described embodiment, it may be joined to the inner face of the apron reinforcement 16 near the joint portion of the apron reinforcement 16 to the suspension housing upper 22. Thus, the apron reinforcement 16 and the bulkhead 40 are joined at a specified position on the inner face of the apron reinforcement 16 which is located in the vicinity of the portion where the suspension housing upper 22 is joined to the apron reinforcement 16.

According to the vehicle-body structure of a vehicle according to the second embodiment of the present invention, since the bulkhead 40 is provided in the closed-section portion 16a of the apron reinforcement 16 formed by the apron reinforcement upper 17 and the apron reinforcement lower 18, the rigidity of the above-described frame and the corresponding portion of the vehicle body formed by this frame can be improved, so that any deformation of these member, collapse of the closed-section portion 16a, and the like can be restrained.

In this case, since the first, third and fourth flange portions 42, 44, 45 of the bulkhead 40 are rigidly joined to the apron reinforcement upper 17 by spot welding and the second and fifth flange portions 43, 46 are joined to the apron reinforcement lower 18 rigidly by spot welding as well as flexibly via the viscoelastic members 47, the bulkhead 40 can be firmly joined to the apron reinforcement 16 with the rigid joint portions, thereby providing the rigid-improvement effect, and the vibration of the apron reinforcement 16 can be reduced with the flexible joint portion, thereby restraining the vibration transmission to passengers in the vehicle compartment.

Further, since the joint portion of the apron reinforcement 16 and the bulkhead 40 is provided at the specified position on the inner face of the apron reinforcement 16 which is located in the vicinity of the portion where the suspension housing upper 22 is joined to the apron reinforcement 16, vibrations inputted to the apron reinforcement 16 from the suspension hosing upper 22 can be effectively reduced.

When the apron reinforcement 16 to which the vehicle-body structure of a vehicle according to the first and second embodiments of the present invention is applied is manufactured, firstly the bulkheads 30, 40 are placed in the apron reinforcement upper 17, and the first and third flange portions 32, 34 of the bulkhead 30 and the first, third and fourth flange portions 42, 43, 44 of the bulkhead 40 are welded to the apron reinforcement upper 17, respectively. Herein, the bulkheads 30, 40 are disposed away from each other in front of and in back of the suspension tower such that these members 30, 40 are joined to the specified positions on the inner face of the apron reinforcement 16 which are located in the vicinity of the portion where the suspension hosing upper 22 is joined to the apron reinforcement 16.

Respective one-side faces of the sheet-shaped the viscoelastic members 37 are made adhere to the seat portion 33a of the second flange portion 33 and the seat portion 35a of the fourth flange portion 35 of the bulkhead 30 with an adhesive force itself, and respective one-side faces of the sheet-shaped the viscoelastic members 47 are made adhere to the seat portion 43a of the second flange portion 43 and the seat portion 46a of the fifth flange portion 46 of the bulkhead 40 with an adhesive force itself.

Then, the apron reinforcement lower 18 is arranged so as to cover over the second flange portion 33 and the fourth flange portion 35 of the bulkhead 30 and the second flange portion 43 and the fifth flange portion 46 of the bulkhead 40, and this apron reinforcement lower 18 is welded to the apron reinforcement upper 17. Subsequently, the second flange portion 33 and the fourth flange portion 35 of the bulkhead 30 are welded to the apron reinforcement lower 18, and the second flange portion 43 and the fifth flange portion 46 of the bulkhead 40 are welded to the apron reinforcement lower 18.

Herein, the other-side faces of the viscoelastic members 37 adhering to the second flange portion 33 and the fourth flange portion 35 of the bulkhead 30 are pressed against and made adhere to the apron reinforcement lower 18, and the other-side faces of the viscoelastic members 47 adhering to the second flange portion 43 and the fifth flange portion 46 of the bulkhead 40 are pressed against and made adhere to the apron reinforcement lower 18.

Then, the suspension housing upper 22 is welded to the vehicle-inside outer face of the apron reinforcement upper 17, and the suspension housing lower 23 is welded to the lower end portion of the suspension housing upper 22. Further, as shown in FIG. 9, the wiper attaching member 25 is attached to the upper face of the suspension housing upper 22.

Thus, the apron reinforcement 16 is manufactured through a rigid joining step of joining the apron reinforcement 16 and the bulkheads 30, 40 with a direct contact thereof and a flexible joining step of joining the apron reinforcement and the bulkheads via the viscoelastic members 37, 47 provided therebetween.

While the bulkheads 30, 40 are joined in the closed-section portion 16a of the apron reinforcement 16 which is formed by the apron reinforcement upper 17 and the apron reinforcement lower 18 in the above-described embodiment, the bulkhead may be joined in a closed-section portion which is formed by a single vehicle-body forming member or three or more vehicle-body forming members.

Further, while the apron reinforcement lower 18 and the bulkheads 30, 40 are rigidly joined by spot welding in the apron reinforcement 16 in the above-described embodiment, they may be rigidly joined by bolt-nut fastening in place of spot welding.

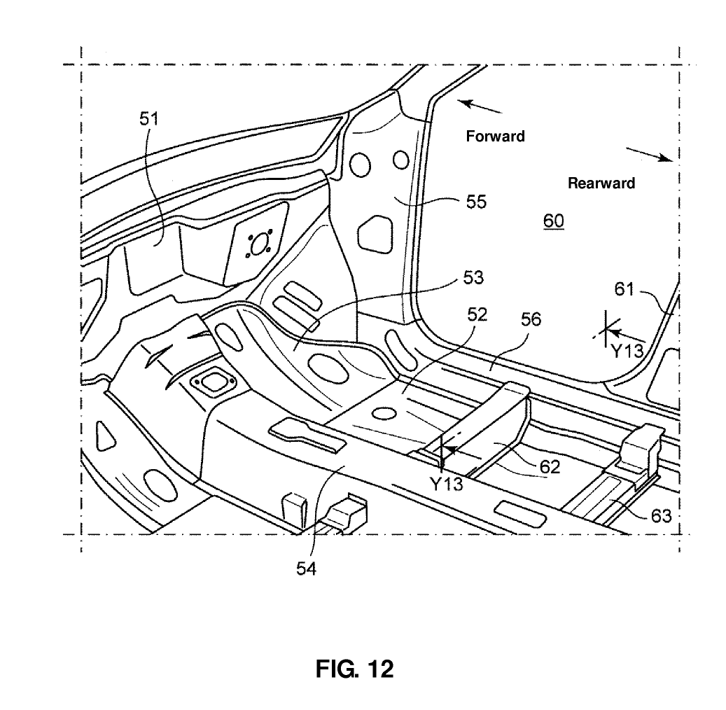

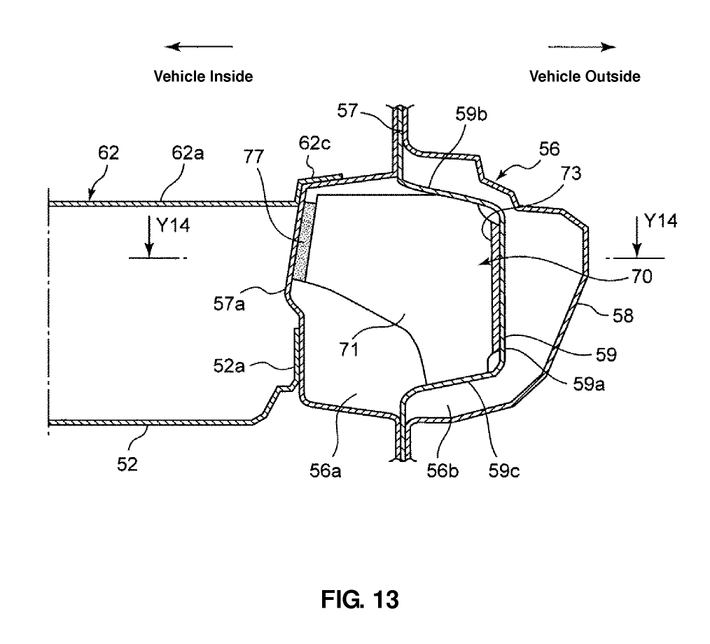

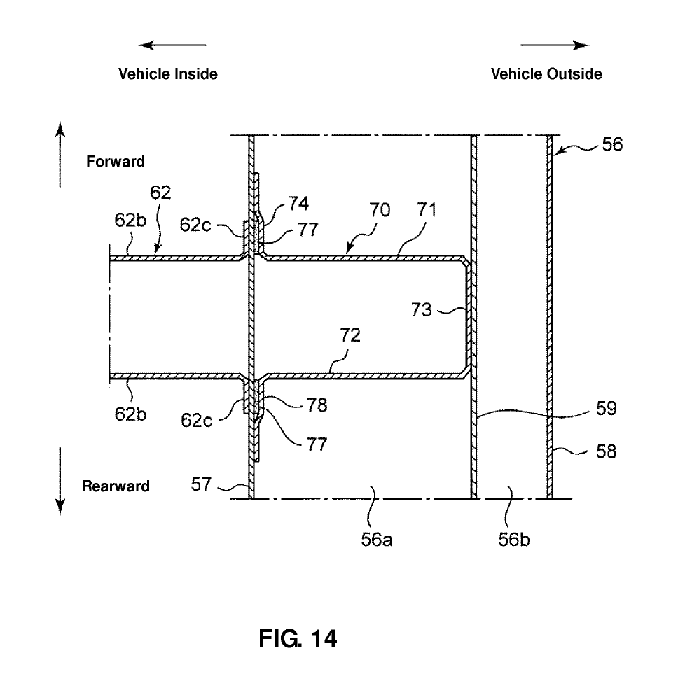

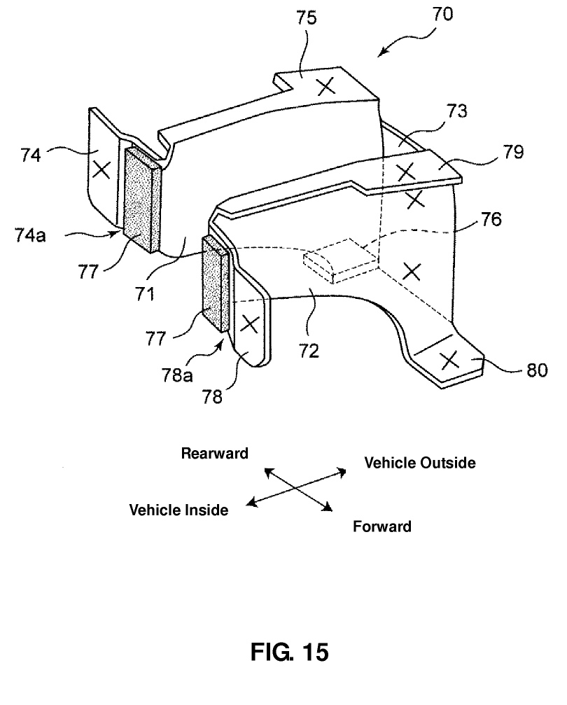

FIG. 12 is a view showing a front portion of the vehicle compartment to which a vehicle-body structure of a vehicle according to a third embodiment of the present invention is applied, FIG. 13 is a sectional view taken along line Y13-Y13 of FIG. 12, FIG. 14 is a sectional view taken along line Y14-Y14 of FIG. 13, and FIG. 15 is a perspective view showing a bulkhead as the reinforcing member according to the third embodiment of the present invention. Herein, FIG. 15 shows a state in which a damping member is attached to the bulkhead.

As shown in FIG. 12, the front portion of the vehicle compartment to which the vehicle-body structure of a vehicle according to the third embodiment of the present invention is applied comprises a dash lower panel 51 which forms a front face of the vehicle compartment, a floor panel 52 which forms a bottom face of the vehicle compartment, a front frame reinforcement 53 which is provided at a foot portion of a front seat between the dash lower penal 51 and the floor panel 52, and others. A tunnel reinforcement 54 is arranged at the center of the bottom face of the vehicle compartment and extends longitudinally.

A hinge pillar 55 to supports a front door (not illustrated) is provided at a side portion of the dash panel 51. A side sill 56 is arranged at a lower end portion of the hinge pillar 55 and extends longitudinally. A center pillar 61 is provided behind a front-door opening portion 60 extends vertically from a central portion, in a vehicle longitudinal direction, of the side sill 56. Further, a No. 2 cross member 62 and a No. 2.5 cross member 63 are arranged on an upper face of the floor panel 52, which extend in the vehicle width direction and interconnect the tunnel reinforcement 54 and the side sill 56, respectively. The No. 2 cross member 62 is disposed substantially at the center between the hinge pillar 55 and the center pillar 61 in the vehicle longitudinal direction, and the No. 2.5 cross member 63 is arranged substantially at the same position as the center pillar 61 in the vehicle longitudinal direction.

As shown in FIG. 13, the side sill 56 comprises a side sill inner 57 which forms a vehicle-body inside of the side sill 56, a side sill outer 58 which forms a vehicle-body outside of the side sill 56, and a side sill reinforcement 59 which is arranged between the side sill inner 57 and the side sill outer 58. In the vehicle according to the present embodiment, a side frame outer is comprised of a side sill outer, a roof rail outer, a hinge pillar outer, a center pillar outer, a rear pillar outer, a front pillar outer and a rear fender which are formed integrally, and the side sill outer 58 forms a portion of the above-described side frame outer. Also, in embodiments which will be described later, the side sill outer, the roof rail outer, the hinge pillar outer, the center pillar outer, the rear pillar outer, the front pillar outer and the rear fender may be formed integrally as the side frame outer.

The side sill inner 57 is formed to protrude toward the vehicle inside and has a substantially U-shaped section, the side sill reinforcement 59 and the side sill outer 58 are formed to protrude toward the vehicle outside and have a substantially U-shaped section, and the side sill inner 57, the side sill reinforcement 59, and the side sill outer 58 are joined at their both end portions.

Thus, a closed-section portion 56a of the side sill 56 is formed by the side sill inner 57 and the side sill reinforcement 59, and a closed-section portion 56b of the side sill 56 is formed by the side sill outer 58 and the side sill reinforcement 59.

A No. 2 cross member 62 is joined to the side sill inner 57. The No. 2 cross member 62 comprises an upper face portion 62a and both-side side face portions 62b, and is formed to have a substantially U-shaped section. A flange portion 62c which is formed at a vehicle-outside end portion of the No. 2 cross member 62 is joined to the side sill inner 57, whereby vibrations are transmitted to side sill inner 57 from the No. 2 cross member 62. Further, a flange portion 52c which is formed at a vehicle-outside end portion of the floor panel 52 is joined to the side sill inner 57.

According to the present embodiment, a bulkhead 70 as the reinforcing member is provided in the closed-section portion 56a of the side sill 56 formed by the side sill inner 57 and the side sill reinforcement 59 at a specified position on an inner face of the side sill 56 which is located in the vicinity of a portion where the No. 2 cross member 62 is joined to the side sill 56.

The bulkhead 70 comprises, as shown in FIG. 15, first and second partition face portions 71, 72 as partition wall portions which partition the closed-section portion 56a and a connection portion 73 which interconnects respective vehicle-outside end portions of the first and second partition face portions 71, 72 in the vehicle longitudinal direction, and is formed to have a U-shaped section as shown in FIG. 14.

The bulkhead 70 comprises a first flange portion 74 which is provided at a vehicle-inside side portion of the first partition face portion 71 and extends forward, a second flange portion 75 which is provided at an upper side portion of the first partition face portion 71 and extends forward, a third flange portion 76 which is provided at a lower side portion of the first partition face portion 71 and extends forward, a fourth flange portion 78 which is provided at a vehicle-inside side portion of the second partition face portion 72 and extends rearward, a fifth flange portion 79 which is provided at an upper side portion of the second partition face portion 72 and extends rearward, and a sixth flange portion 80 which is provided at a lower side portion of the second partition face portion 72 and extends rearward. A seat portion 74a is formed at the first flange portion 74 in a recess shape so as to accommodate a viscoelastic member 77 therein, which will be described specifically. A seat portion 78a is formed at the fourth flange portion 78 in the recess shape so as to accommodate another viscoelastic member 77 therein.

The connection portion 73 of the bulkhead 70 is joined to a vertical face portion 59a of the side sill reinforcement 59 which protrudes by spot welding, the second and fifth flange portions 75, 79 of the bulkhead 70 are joined to an upper-side horizontal face portion 59b of the side sill reinforcement 59 which protrudes by spot welding, and the third and sixth flange portions 76, 80 of the bulkhead 70 are joined to a lower-side horizontal face portion 59c of the side sill reinforcement 59 which protrudes by spot welding.

The first flange portion 74 of the bulkhead 70 is joined to a vertical face portion 57a of the side sill inner 57 which protrudes by spot welding, and the viscoelastic member 77 as the vibration damping member which is placed and adheres onto the seat portion 74a of the first flange portion 74 is made adhere to the vertical face portion 57a of the side sill inner 57. Thus, the first flange portion 74 is joined to the side sill inner 57 via the viscoelastic member 77.

Likewise, the fourth flange portion 78 is joined to the vertical face portion 57a of the side sill inner 57 by spot welding. The viscoelastic member 77 which is placed and adheres onto the seat portion 78a of the fourth flange portion 78 is made adhere to the vertical face portion 57a of the side sill inner 57, whereby the fourth flange portion 78 is joined to the side sill inner 57 via the viscoelastic member 77. As shown in FIG. 14, the bulkhead 70 is provided such that the side face portion 62b of the No. 2 cross member 62 and the partition face portions 71, 72 are located substantially on a straight line.

Herein, the respective sheet-shaped viscoelastic members 77 are made adhere to the seat portions 74a, 78a of the bulkhead 70, this bulkhead 70 is arranged in the side sill reinforcement 59 to which the side sill outer 58 is joined, corresponding to a portion where the No. 2 cross member 62 is provided, and the connection portion 73, the second flange portion 75, the third flange portion 76, the fifth flange portion 79 and the sixth flange portion 80 are respectively joined to the side sill reinforcement 59. Then, the side sill inner 57 to which the No. 2 cross member 62 is joined is assembled from the vehicle inside, the side sill inner 57 and the side sill reinforcement 59 are joined together, and the first and fourth flange portions 74, 78 are respectively joined to the side sill inner 57. Thus, the bulkhead 70 is attached in the closed-section portion 56.

In a state in which the bulkhead 70 is provided in the closed-section portion 56a formed by the side sill inner 57 and the side sill reinforcement 59, the spot-welding joint portions of the bulkhead 70 to the frame comprised of the side sill inner 57 and the side sill reinforcement 59 constitute the rigid joint portions. Meanwhile, the joint portions via the viscoelastic members constitute the flexible joint portions. In FIG. 15, the spot-welding portions of the bulkhead 70 are shown by x marks.

According to the vehicle-body structure of a vehicle according to the third embodiment of the present invention, since the bulkhead 70 is provided in the closed-section portion 56a of the frame formed by the side sill inner 57 and the side sill reinforcement 59, the rigidity of the above-described frame and the corresponding portion of the vehicle body formed by this frame can be improved, so that any deformation of these members, collapse of the closed-section portion 56a, and the like can be restrained.

In this case, since the bulkhead 70 is rigidly joined to the side sill inner 57 and the side sill reinforcement 59 and flexibly joined to the side sill inner 57 via the viscoelastic members 77, the bulkhead 70 can be firmly joined to the above-described frame with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the side sill inner 57 and the side sill reinforcement 59 to the bulkhead 70 are provided at a specified position on an inner face of the frame which is located in the vicinity of a portion where the No. 2 cross member 62 is joined to the frame, vibrations inputted to the frame from the No. 2 cross member 62 can be reduced effectively.

Moreover, the bulkhead 70 is comprised of the two sheet-shaped partition face portions 71, 72 which partition the closed-section portion 56a and the connection portion 73 which interconnects these partition face portions 71, 72, the rigidity-improvement effect by the bulkhead 70 can extend over a properly-wide area of the frame forming the closed-section portion 56a. Further, the number of parts can be reduced by half, compared with a case in which two separate bulkheads are arranged at two adjacent positions in the closed-section portion 56a, thereby improving efficiencies of parts management and assembling works.

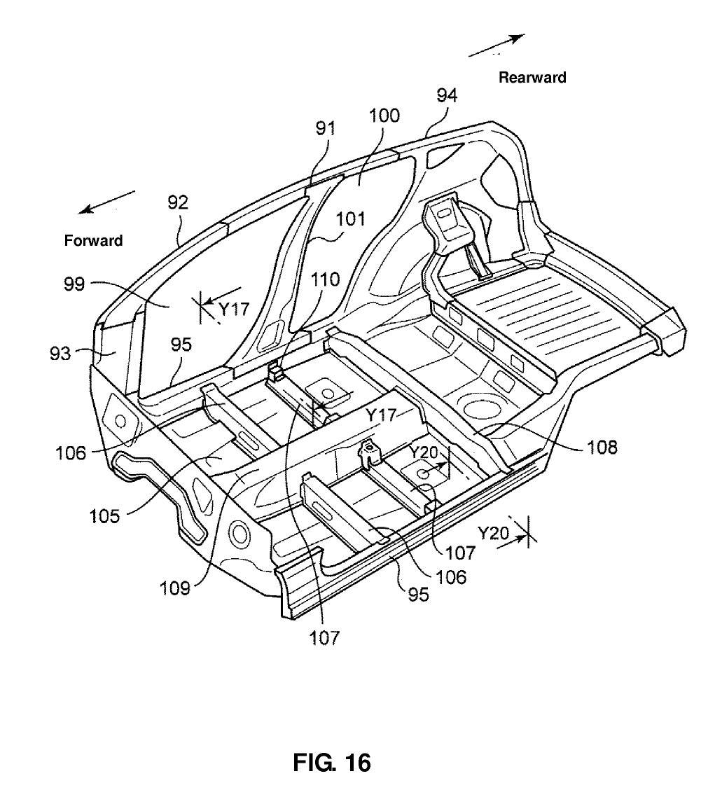

FIG. 16 is a view showing a side portion and a bottom portion of the vehicle compartment to which a vehicle-body structure of a vehicle according to fourth through eighth embodiments of the present invention is applied. As shown in FIG. 16, the right-side side portion of the vehicle compartment to which the vehicle-body structure of a vehicle according to the fourth through eighth embodiments of the present invention is applied comprises a roof rail 91 which extends in the vehicle longitudinal direction at an upper portion of the vehicle body, a front pillar 92 which extends forward from an front end portion of the roof rail 91, a hinge pillar 93 which extends downward from a front end portion of the front pillar 92, a rear pillar 94 which extends rearward and downward from a rear end portion of the roof rail 91, a side sill 95 which extends in the vehicle longitudinal direction at a lower portion of the vehicle body and is joined to the hinge pillar 93 and the rear pillar 94, and a center pillar 101 which extends vertically between front and rear door opening portions 99, 100 and is joined to the roof rail 91 and the side sill 95. Herein, while the left-side side portion of the vehicle compartment is constituted similarly to the above-described right-side side portion of the vehicle compartment, only the side sill 95 of the left side is illustrated in FIG. 6, omitting the center pillar and others, for easier viewing.

Further, a floor panel 105 is provided as a member forming the bottom face of the vehicle compartment, and at this floor panel 105 are arranged a No. 2 cross member 106, a No. 2.5 cross member 107 and a No. 3 cross member 108 which extend in the vehicle width direction, respectively. These cross members 106, 107, 108 are respectively joined to a tunnel reinforcement 109 which extends in the vehicle longitudinal direction at the center of the bottom face of the vehicle compartment, and also respectively joined to the side sills 95. The No. 2 cross member 106 and the No. 2.5 cross member 107 are split into two parts laterally, respectively.

The side sills 95 are joined to the No. 2 cross member 106 at substantially a central position between the hinge pillar 93 and the center pillar 101 in the vehicle longitudinal direction, and joined to the No. 2.5 cross member 107 substantially at the same position as the center pillar 101 in the vehicle longitudinal direction, and joined to the No. 3 cross member 108 at substantially a central position between the center pillar 101 and the rear pillar 94 in the vehicle longitudinal direction.

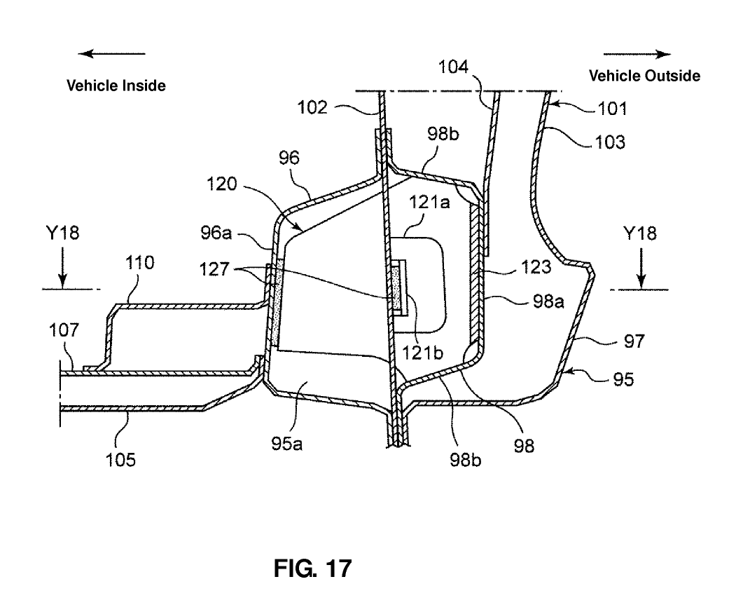

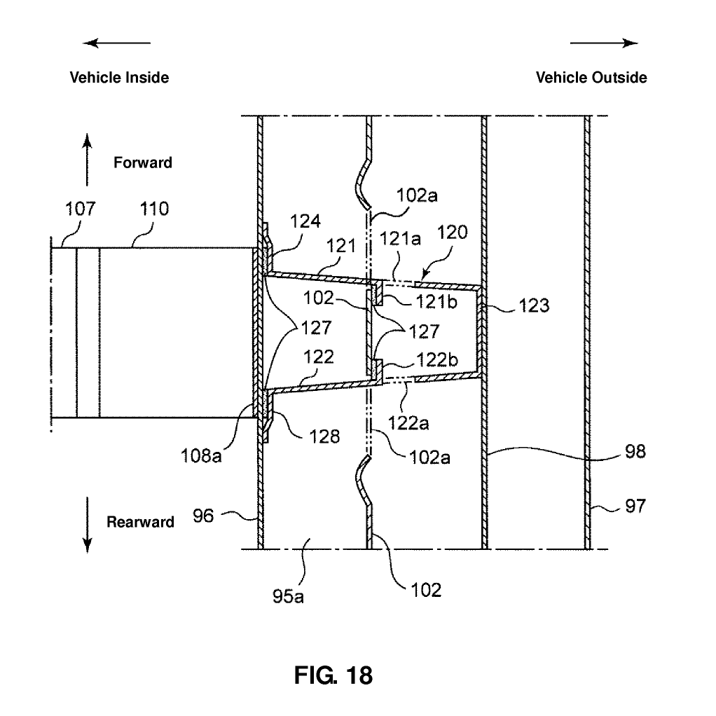

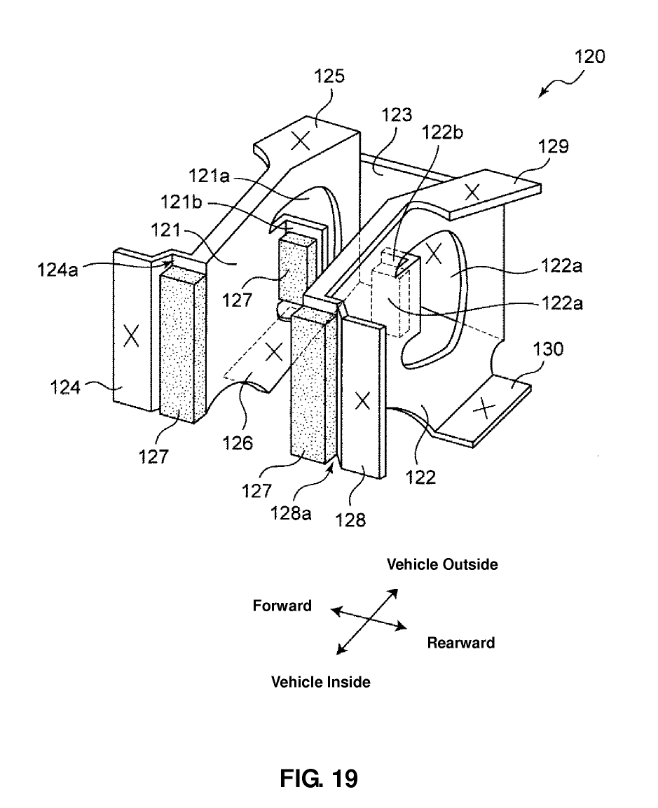

A vehicle-body structure of a vehicle according to the fourth embodiment of the present invention will be described referring to FIGS. 17 through 19. FIG. 17 is a sectional view taken along line Y17-Y17 of FIG. 16, FIG. 18 is a sectional view taken along line Y18-Y18 of FIG. 17, and FIG. 19 is a perspective view showing a bulkhead as the reinforcing member according to the fourth embodiment of the present invention. Herein, FIG. 19 shows a state in which a damping member is attached to the bulkhead.

As shown in FIG. 17, the side sill 95 comprises a side sill inner 96 which forms a vehicle-body inside of the side sill 95, a side sill outer 97 which forms a vehicle-body outside of the side sill 95, and a side sill reinforcement 98 which is provided between the side sill inner 96 and the side sill outer 97.

The side sill inner 96 is formed to protrude toward the vehicle inside and have a U-shaped section, and the side sill reinforcement 98 is formed to protrude toward the vehicle outside and have a U-shaped section. The side sill inner 96 and the side sill reinforcement 98 are joined at their upper-and-lower both end portions. A closed-section portion 95a is formed by the side sill inner 96 and the side sill reinforcement 98. The side sill outer 97 is joined to the side sill inner 96 and the side sill reinforcement 97 at its lower end portion, covering a vehicle-outside of the side sill reinforcement.

The center pillar 101 joined to the side sill 95 comprises a center pillar inner 102 which forms a vehicle-body inside of the center pillar 101, a center pillar outer 103 which forms a vehicle-body outside of the center pillar 101, and a center pillar reinforcement 104 which is provided between the center pillar inner 102 and the center pillar outer 103.

At a joint portion of the side sill 95 and the center pillar 101, a lower end portion of the center pillar inner 102 extends over between the side sill inner 96 and the side sill reinforcement 98, and a lower end portion of the center pillar reinforcement 104 is joined to an vehicle-outside of a vertical face portion 98a of the side sill reinforcement 98 which protrudes. The center pillar outer 103 is formed integrally with the side sill outer 97.

Two opening portions 102a are formed at the center pillar inner 102 so that the center pillar inner 102 can be assembled in the side sill 95, avoiding any interference with the bulkhead 120 arranged in the closed-section portion 95a formed by the side sill inner 96 and the side sill reinforcement 98.

A vehicle-outside end portion of the No. 2 cross member 107 and a vehicle-outside end portion of the floor panel 105 are joined to the vertical face portion 96a of the side sill inner 96 which protrudes toward the vehicle inside. A seat-rail attaching member 110 to attach a seat rail (not illustrated) is arranged on an upper face of the No. 2.5 cross member 107, and joined to the No. 2.5 cross member 107 and the vertical face portion 96a of the side sill inner 96. Thus, vibrations from the seat-rail attaching member 110 are transmitted to the side sill inner 96.

The bulkhead 120 as the reinforcing member is provided in the closed-section portion 95a of the side sill 95 formed by the side sill inner 96 and the side sill reinforcement 98 at a specified position on an inner face of the side sill inner 96 which is located in the vicinity of a portion where the seat-rail attaching member 110 is joined to the side sill inner 96.

The bulkhead 120 comprises, as shown in FIG. 19, first and second partition face portions 121, 122 as partition wall portions which partition the closed-section portion 95a and a connection portion 123 which interconnects respective vehicle-outside end portions of the first and second partition face portions 121, 122 in the vehicle longitudinal direction, and is formed to have a U-shaped section as shown in FIG. 18.

The bulkhead 120 comprises a first flange portion 124 which is provided at a vehicle-inside side portion of the first partition face portion 121 and extends forward, a second flange portion 125 which is provided at an upper side portion of the first partition face portion 121 and extends forward, a third flange portion 126 which is provided at a lower side portion of the first partition face portion 121 and extends forward, a fourth flange portion 128 which is provided at a vehicle-inside side portion of the second partition face portion 122 and extends rearward, a fifth flange portion 129 which is provided at an upper side portion of the second partition face portion 122 and extends rearward, and a sixth flange portion 130 which is provided at a lower side portion of the second partition face portion 122 and extends rearward. A first seat portion 124a is formed at the first flange portion 124 in a recess shape so as to accommodate a viscoelastic member 127 therein, which will be described specifically. A second seat portion 128a is formed at the fourth flange portion 128 in the recess shape so as to accommodate another viscoelastic member 127 therein.

Further, an opening portion 121a is formed at the first partition face portion 121 of the bulkhead 120, and a third seat portion 121b is formed by cutting out partially from the first flange portion 121 so as to accommodate another viscoelastic member 127 therein. Likewise, an opening portion 122a is formed at the second partition face portion 122 of the bulkhead 120, and a fourth seat portion 122b is formed by cutting out partially from the second flange portion 122 so as to accommodate further another viscoelastic member 127 therein.

The connection portion 123 of the bulkhead 120 is joined to the vertical face portion 98a of the side sill reinforcement 98, the second and fifth flange portions 125, 129 of the bulkhead 120 are joined to an upper-side horizontal face portion 98b of the side sill reinforcement 98 which protrudes by spot welding, and the third and sixth flange portions 126, 130 of the bulkhead 120 are joined to a lower-side horizontal face portion 98b of the side sill reinforcement 98 which protrudes by spot welding.

The first flange portion 124 of the bulkhead 120 is joined to the vertical face portion 96a of the side sill inner 96 by spot welding, and the viscoelastic member 127 as the vibration damping member which is placed and adheres onto the first seat portion 124a of the first flange portion 124 is made adhere to the vertical face portion 96a of the side sill inner 96. Thus, the first flange portion 124 is joined to the side sill inner 96 via the viscoelastic member 127.

Likewise, the fourth flange portion 128 is joined to the vertical face portion 96a of the side sill inner 96 by spot welding. The viscoelastic member 127 which is placed and adheres onto the second seat portion 128a of the fourth flange portion 128 is made adhere to the vertical face portion 96a of the side sill inner 96, whereby the fourth flange portion 128 is joined to the side sill inner 96 via the viscoelastic member 127.

The viscoelastic members 127 which are respectively placed on and adhere to the third and forth seat portions 121b, 122b are made adhere to the center pillar inner 102, whereby the bulkhead 120 is joined to the center pillar inner 102 via the viscoelastic members 127.

Herein, the respective sheet-shaped viscoelastic members 127 are made adhere to the seat portions 124a, 128a, 121b, 122b of the bulkhead 120, this bulkhead 120 is arranged in the side sill reinforcement 98 to which the center pillar reinforcement 104 and the side sill outer 95 are joined, corresponding to a portion where the seat-rail attaching member 110 is provided, and the connection portion 123, the second flange portion 125, the third flange portion 126, the fifth flange portion 129 and the sixth flange portion 130 are respectively joined to the side sill reinforcement 98. Then, the center pillar inner 102 is assembled from the vehicle inside, the center pillar inner 102 and the seat portions 121b, 122b are joined together via the viscoelastic members 127. Subsequently, the side sill inner 96 to which the seat-rail attaching member 110 is joined is assembled form the vehicle inside, and the side sill inner 96 and the side sill reinforcement 98 are joined and the first and fourth flange portions 124, 128 are respectively joined to the side sill inner 96. Thus, the bulkhead 120 is attached in the closed-section portion 95a.

In a state in which the bulkhead 120 is provided in the closed-section portion 95a formed by the side sill inner 96 and the side sill reinforcement 98, the spot-welding joint portions of the bulkhead 120 to the frame comprised of the side sill inner 96 and the side sill reinforcement 98 constitute the rigid joint portions. Meanwhile, the joint portions via the viscoelastic members constitute the flexible joint portions. In FIG. 19, the spot-welding portions of the bulkhead 120 are shown by x marks.

According to the vehicle-body structure of a vehicle according to the fourth embodiment of the present invention, since the bulkhead 120 is rigidly joined to the side sill inner 96 and the side sill reinforcement 98 and flexibly joined to the side sill inner 96 via the viscoelastic members 127, the bulkhead 120 can be firmly joined to the frame formed by the side sill inner 96 and the side sill reinforcement 98 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the side sill inner 96 and the side sill reinforcement 98 to the bulkhead 120 are provided at a specified position on an inner face of the frame which is located in the vicinity of a portion where the seat-rail attaching member 110 is joined to the frame, vibrations inputted to the frame from the seat-rail attaching member 110 can be reduced effectively.

Moreover, the bulkhead 120 is comprised of the two sheet-shaped partition face portions 121, 122 which partition the closed-section portion 95a and the connection portion 123 which interconnects these partition face portions 121, 122, the rigidity-improvement effect by the bulkhead 120 can extend over a properly-wide area of the frame forming the closed-section portion 95a. Further, the number of parts can be reduced by half, compared with a case in which two separate bulkheads are arranged at two adjacent positions in the closed-section portion 95a, thereby improving efficiencies of parts management and assembling works.

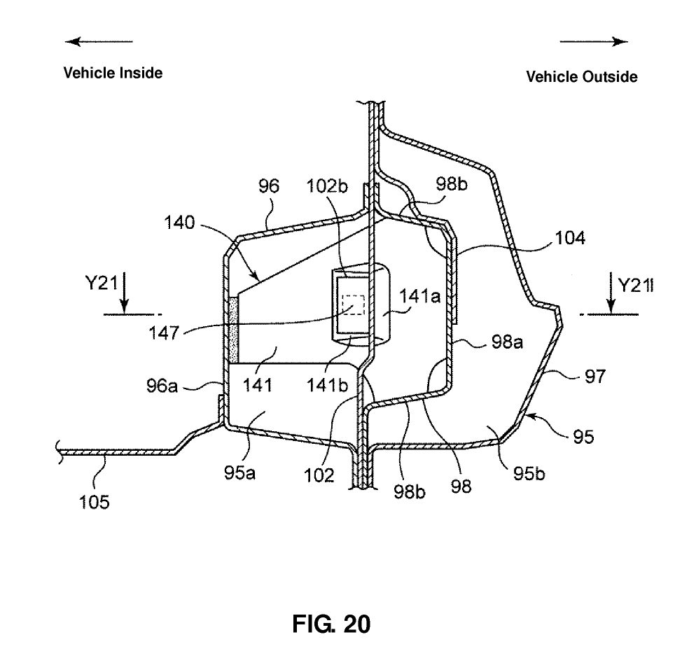

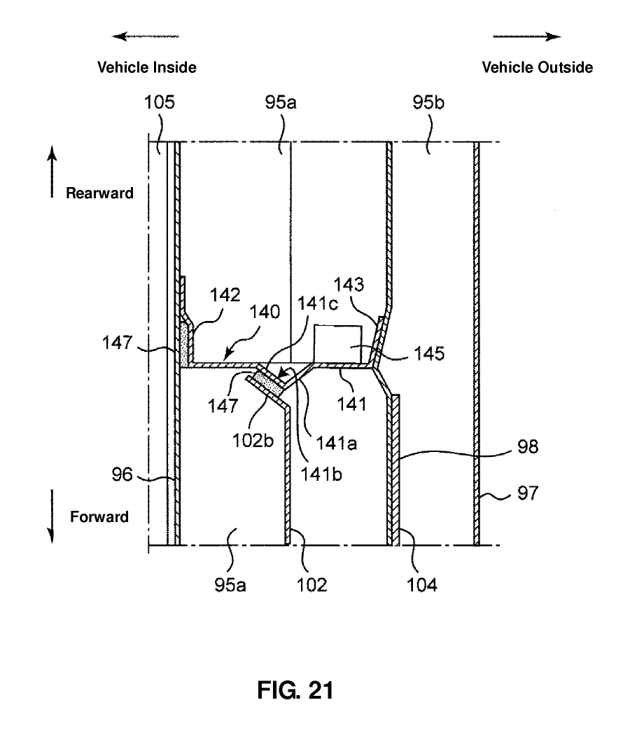

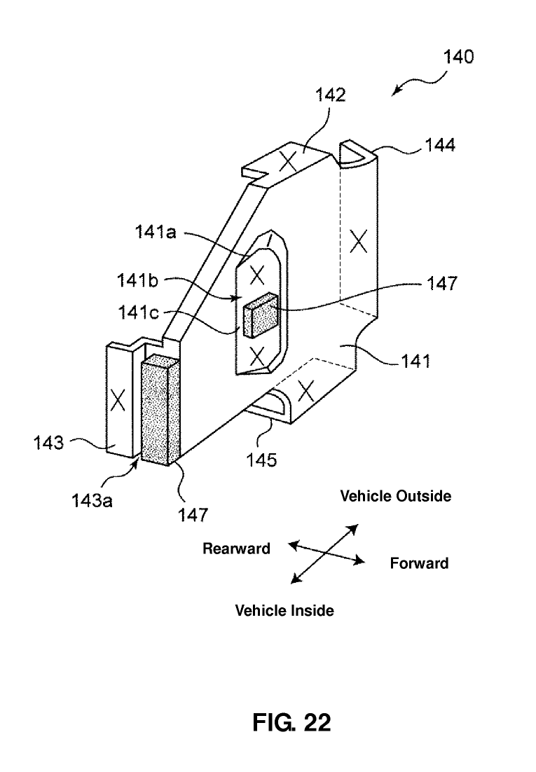

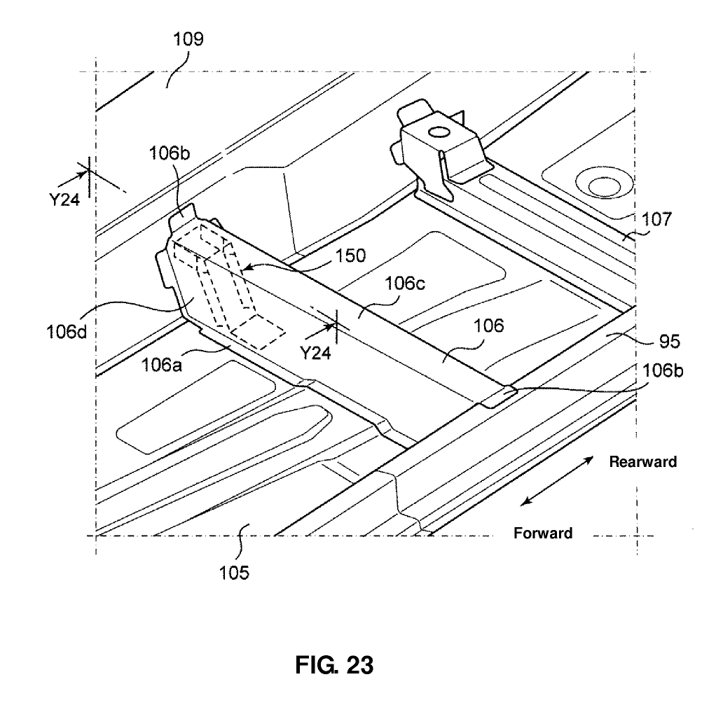

A vehicle-body structure of a vehicle according to the fifth embodiment of the present invention will be described referring to FIGS. 20 through 22. FIG. 20 is a sectional view taken along line Y20-Y20 of FIG. 16, FIG. 21 is a sectional view taken along line Y21-Y21 of FIG. 20, and FIG. 22 is a perspective view showing a bulkhead as the reinforcing member according to the fifth embodiment of the present invention. Herein, FIG. 22 shows a state in which a damping member is attached to the bulkhead.

As described above, the side sill 95 comprises the side sill inner 96, the side sill outer 97, and the side sill reinforcement 98, and is provided such that at a joint portion of the side sill 95 and the center pillar 101, the center pillar inner 102 extends in the closed-section portion 95a formed by the side sill inner 96 and the side sill reinforcement 98, and the center pillar reinforcement 104 is joined to the vertical face portion 98a of the side sill reinforcement 98.

At a portion located in back of the center pillar 101, the side sill inner 96, the side sill outer 97, and the side sill reinforcement 98 are joined together at their upper and lower end portions, so that the closed-section portion 95a is formed by the side sill inner 96 and the side sill reinforcement 98, and the closed-section portion 95b is formed by the side sill outer 97 and the side sill reinforcement 98.

As shown in FIGS. 20 and 21, at the portion located in back of the joint portion of the side sill 95 to the center pillar 101, a bulkhead 140 as the reinforcing member is provided in the closed-section portion 95a formed by the side sill inner 96 and the side sill reinforcement 98 at a specified position on an inner face of the side sill inner 96 which is located in the vicinity of a portion where the center pillar reinforcement 104 is joined to the side sill inner 98.

The bulkhead 140 comprises, as shown in FIG. 22, a partition face portion 141 as a partition wall portion which partitions the closed-section portion 95a, a first flange portion 142 which is provided at an upper side portion of the partition face portion 141 and extends rearward, a second flange portion 143 which is provided at a vehicle-inside side portion of the partition face portion 141 and extends rearward, a third flange portion 144 which is provided at a vehicle-outside side portion of the partition face portion 141 and extends rearward, and a fourth flange portion 145 which is provided at a lower side portion of the partition face portion 141 and extends rearward. A first seat portion 143a is formed at the second flange portion 143 in a recess shape so as to accommodate a viscoelastic member 147 therein, which will be described specifically.

The bulkhead 140 further includes a protrusion portion 141a which protrudes forward from the partition face portion 141. The protrusion portion 141 has a slant face portion 141b which slants relative to the partition face portion 141 by a specified slant angle, and a second seat portion 141c to place another viscoelastic member 147 thereon is provided at the slant face portion 141b.

The first, third and fourth flange portions 142, 144, 145 of the bulkhead 140 are respectively joined to the upper-side horizontal face portion 98b, the vertical face portion 98a, and the lower-side horizontal face portion 98b of the side sill reinforcement 98 by spot welding. The second flange portion 143 of the bulkhead 140 is joined to the vertical face portion 96a of the side sill inner 96 by spot welding, and the viscoelastic member 147 as the vibration damping member which is placed and adheres onto the first seat portion 143a of the second flange portion 143 is made adhere to the vertical face portion 96a of the side sill inner 96. Thus, the second flange portion 143 is joined to the side sill inner 96 via the viscoelastic member 147.

Moreover, the slant face portion 141b of the bulkhead 140 is joined to a flange portion 102b which is provided in back of the center pillar inner 102 by spot welding, and the viscoelastic member 147 as the vibration damping member which is placed and adheres onto the second seat portion 141c is made adhere to the flange portion 102b of the center pillar inner 102. Thus, the slant face portion 141b is joined to the center pillar inner 102 via the viscoelastic member 147. A portion of the flange portion 102b of the center pillar 102 which is joined to the bulkhead 140 via the viscoelastic member 147 is formed in a recess shape.

Herein, the respective sheet-shaped viscoelastic members 147 are made adhere to the seat portions 143a, 141c of the bulkhead 140, this bulkhead 140 is arranged in the side sill reinforcement 98 to which the center pillar reinforcement 104 and the side sill outer 95 are joined, corresponding to a portion where the center pillar reinforcement 104 is provided, and the first flange portion 142, the third flange portion 144, and the fourth flange portion 145 are respectively joined to the side sill reinforcement 98. Then, the center pillar inner 102 is assembled from the vehicle inside, the center pillar inner 102 and the seat portion 141c are joined together via the viscoelastic members 147. The side sill inner 96 and the side sill reinforcement 98 are joined and the second flange portion 143 is joined to the side sill inner 96. Thus, the bulkhead 140 is attached in the closed-section portion 95a.

In a state in which the bulkhead 140 is provided in the closed-section portion 95a formed by the side sill inner 96 and the side sill reinforcement 98, the spot-welding joint portions of the bulkhead 140 to the frame comprised of the side sill inner 96 and the side sill reinforcement 98 constitute the rigid joint portions. Meanwhile, the joint portions via the viscoelastic members constitute the flexible joint portions. In FIG. 22, the spot-welding portions of the bulkhead 140 are shown by x marks.

According to the vehicle-body structure of a vehicle according to the fifth embodiment of the present invention, since the bulkhead 140 is rigidly joined to the side sill inner 96 and the side sill reinforcement 98 and flexibly joined to the side sill inner 96 via the viscoelastic members 147, the bulkhead 140 can be firmly joined to the frame formed by the side sill inner 96 and the side sill reinforcement 98 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the side sill inner 96 and the side sill reinforcement 98 to the bulkhead 140 are provided at a specified position on an inner face of the frame which is located in the vicinity of a portion where the center pillar reinforcement 104 is joined to the frame, vibrations inputted to the frame from the center pillar reinforcement 104 can be reduced effectively.

While the bulkhead 140 is provided in the closed-section portion 95a of the side sill 95 at a position in back of the joint portion to the center pillar 101 in the present embodiment, this bulkhead may be provided in the closed-section portion 95a of the side sill 95 at another position in front of the joint portion to the center pillar 101.

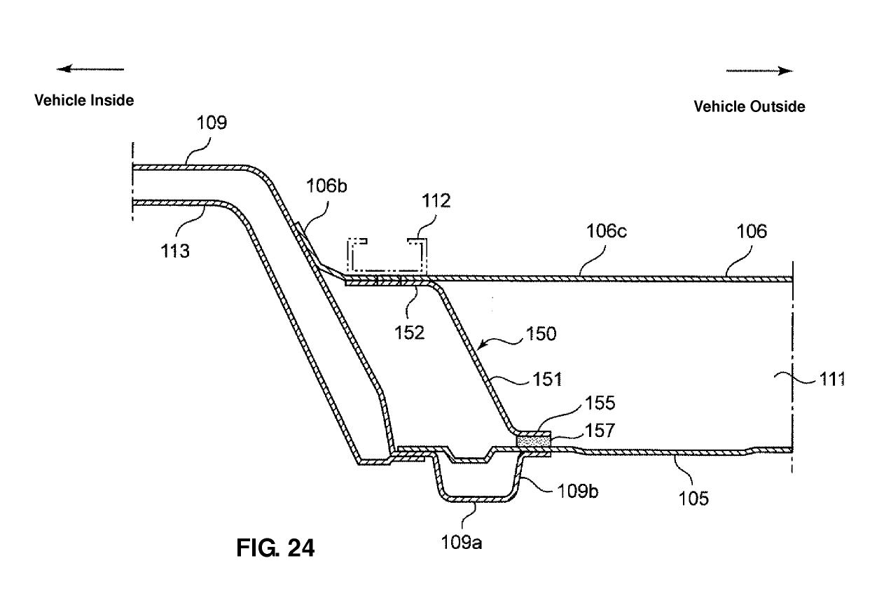

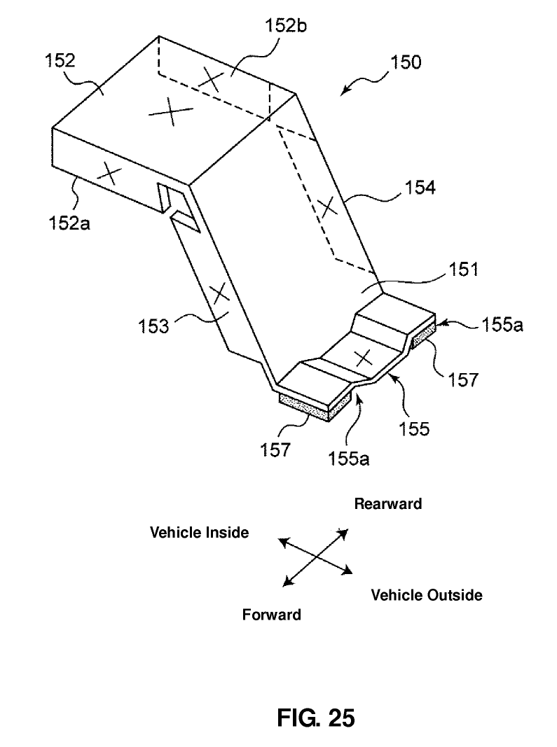

A vehicle-body structure of a vehicle according to a sixth embodiment of the present invention will be described referring to FIGS. 23 through 25. FIG. 23 is an enlarged view of a first major part of FIG. 16, FIG. 24 is a sectional view taken along line Y24-Y24 of FIG. 23, and FIG. 25 is a perspective view showing a bulkhead as the reinforcing member according to the sixth embodiment of the present invention. Herein, FIG. 25 shows a state in which a damping member is attached to the bulkhead.

As shown in FIG. 23, the No. 2 cross member 106 arranged on the upper face of the floor panel 105 has a U-shaped section and extends in the vehicle width direction. A flange portion 106a of the No. 2 cross member 106 which extends in the vehicle longitudinal direction is joined to the floor panel 105, and flange portions 106b which are provided at both-side end portions, in the vehicle width direction, of the No. 2 cross member 106 are joined to the tunnel reinforcement 109 and the side sill 95, respectively.

As shown in FIG. 24, a closed-section portion 111 is formed by the No. 2 cross member 106 and the floor panel 105, a seat rail 112 to support a seat for passenger (not illustrated) is arranged on an outer face of the closed-section portion 111, and this seat rail 112 is attached to an upper face portion 106c of the No. 2 cross member 106. The tunnel reinforcement 109 has a U-shaped section and includes a protrusion portion 109a which is formed at a vehicle-outside end portion and protrudes downward, having substantially a rectangular section. This tunnel reinforcement 109 is joined to a lower face of the floor panel 105.

A tunnel frame 113 which is formed to have a U-shaped section is provided below the tunnel reinforcement 109, and a vehicle-outside end portion of the tunnel frame 113 is joined together with the floor panel 105 and the tunnel reinforcement 109 on the vehicle inside of the protrusion portion 109a of the tunnel reinforcement 109.

A bulkhead 150 as the reinforcing member is provided in the closed-section portion 111 formed by the No. 2 cross member 106 and the floor panel 105 at a specified position on an inner face of the No. 2 cross member 106 which is located in the vicinity of a portion where the seat rail 112 is joined to the No. 2 cross member 106 as well as at another specified position on the inner face of the floor panel 105 which is located in the vicinity of a portion where the tunnel reinforcement 109 is joined to the floor panel 105.

The bulkhead 150 comprises, as shown in FIG. 25, a partition face portion 151 as a partition wall portion which partitions the closed-section portion 111, a first flange portion 152 which is provided at an upper side portion of the partition face portion 151 and extends toward the vehicle inside, a second flange portion 153 which is provided at a forward side portion of the partition face portion 151 and extends toward the vehicle inside, a third flange portion 154 which is provided at a rearward side portion of the partition face portion 151 and extends toward the vehicle inside, and a fourth flange portion 155 which is provided at a lower side portion of the partition face portion 151 and extends toward the vehicle outside.

The bulkhead 150 further includes fifth and sixth flange portions 152a, 152b which extend downward respectively from front and rear side portions of the first flange portion 152 substantially perpendicularly. A seat portion 155a to place a viscoelastic member 157 thereon, which will be described below, is formed at the fourth flange portion 155 in a recess shape.

The first flange portion 152 of the bulkhead 150 is joined to the upper face portion 106c of the No. 2 cross member 106 by spot welding, the second and fifth flange portions 153, 152a of the bulkhead 150 are joined to a forward side face portion 106d of the No. 2 cross member 106 by spot welding, the third and sixth flange portions 154, 152b of the bulkhead 150 are joined to a rearward side face portion of the No. 2 cross member 106 by spot welding. Further, the fourth flange portion 155 of the bulkhead 150 is joined to the floor panel 105 by spot welding, and the viscoelastic member 157 as the vibration damping member which is placed and adheres onto the seat portion 155a of the fourth flange portion 155 is made adhere to the floor panel 105. Thus, the fourth flange portion 155 is joined to the floor panel 105 via the viscoelastic member 157. As shown in FIG. 24, the bulkhead 150 is provided such that a vehicle-outside side face portion 109b of the protrusion portion 109a of the tunnel reinforcement 109 and the partition face portion 151 are substantially continuous.

Herein, the viscoelastic members 157 are made adhere to the seat portions 155a of the bulkhead 150, this bulkhead 150 is arranged in the No. 2 cross member 106, corresponding to a portion where the seat rail 112 and the tunnel reinforcement 109 are provided, and the first flange portion 152, the second flange portion 153, the third flange portion 154, the fifth flange portion 152a, and the sixth flange portion 152 are respectively joined to the No. 2 cross member 106. Then, the flange portion 106a of the No. 2 cross member 106 is joined to the floor panel 105 to which the tunnel reinforcement 109 and the tunnel frame 113 are respectively joined, and the flange portion 106b of the No. 2 cross member 106 is joined to the tunnel reinforcement 109. Then, the fourth flange portion 155 is joined to the floor panel 105. Thus, the bulkhead 150 is attached in the closed-section portion 111. Then, the seat rail 112 is joined onto the outer face of the No. 2 cross member 106.

In a state in which the bulkhead 150 is provided in the closed-section portion 111 formed by the No. 2 cross member 106 and the floor panel 105, the spot-welding joint portions of the bulkhead 150 to the frame comprised of the No. 2 cross member 106 and the floor panel 105 constitute the rigid joint portions. Meanwhile, the joint portions via the viscoelastic members constitute the flexible joint portions. In FIG. 25, the spot-welding portions of the bulkhead 150 are shown by x marks.

According to the vehicle-body structure of a vehicle according to the sixth embodiment of the present invention, since the bulkhead 150 is rigidly joined to the No. 2 cross member 106 and the floor panel 105 and flexibly joined to the floor panel 105 via the viscoelastic members 157, the bulkhead 150 can be firmly joined to the frame formed by the No. 2 cross member 106 and the floor panel 105 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the No. 2 cross member 106 and the floor panel 105 to the bulkhead 150 are provided at a specified position on an inner face of the frame which is located in the vicinity of a portion where the seat rail 112 is joined to the frame and at a specified position on the inner face of the frame which is located in the vicinity of a portion where the tunnel reinforcement 109 is joined to the frame, vibrations inputted to the frame from the seat rail 112 and the tunnel reinforcement 109 can be reduced effectively.

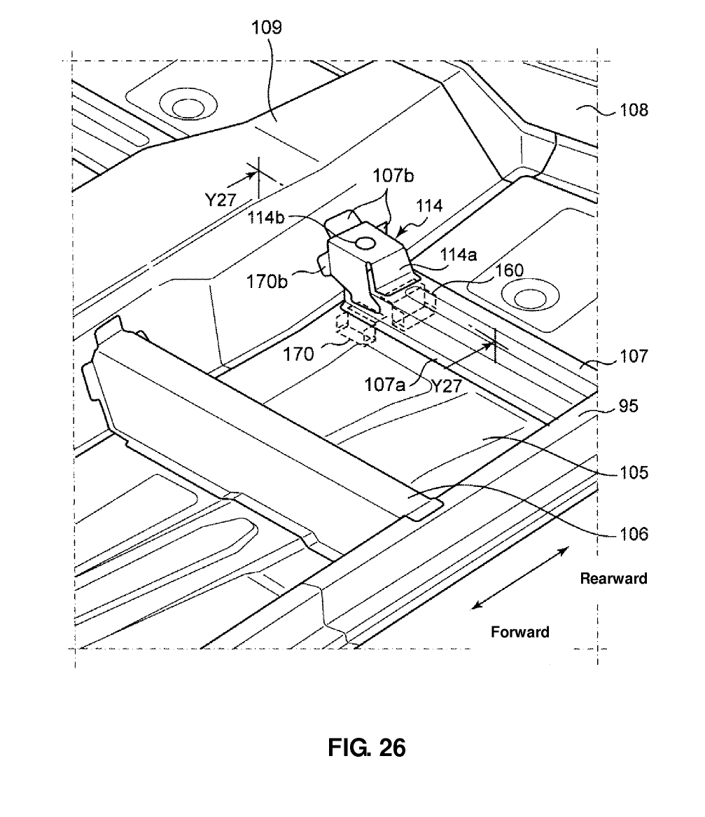

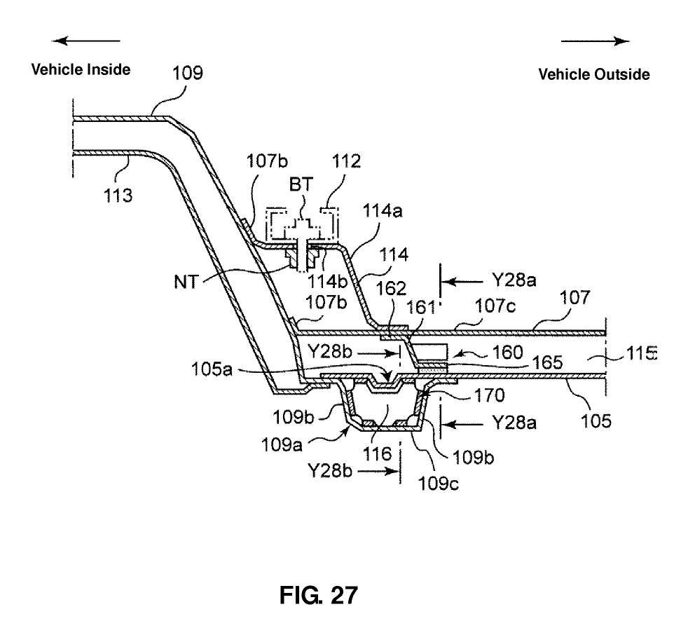

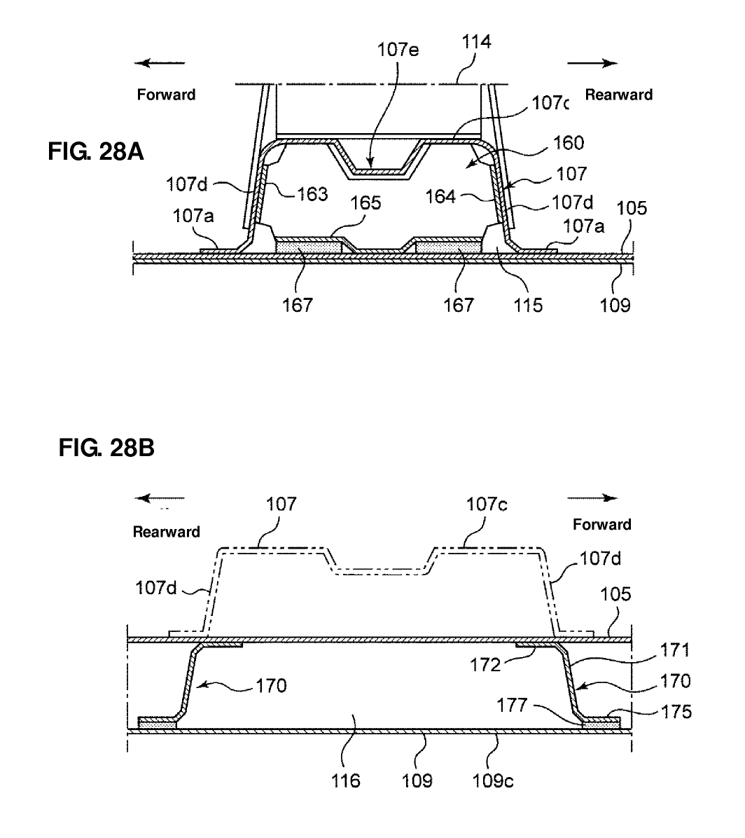

A vehicle-body structure of a vehicle according to a seventh embodiment of the present invention will be described referring to FIGS. 26 through 30. FIG. 26 is an enlarged view of a second major part of FIG. 16, FIG. 27 is a sectional view taken along line Y27-Y27 of FIG. 26, FIGS. 28A and 28B are sectional views taken along lines Y28a-Y28a and Y28b-Y28b of FIG. 27.

As shown in FIG. 23, the No. 2.5 cross member 107 arranged on the upper face of the floor panel 105 has a U-shaped section and extends in the vehicle width direction. A flange portion 107a of the No. 2.5 cross member 107 which extends in the vehicle longitudinal direction is joined to the floor panel 105, and flange portions 107b which are provided at both-side end portions, in the vehicle width direction, of the No. 2.5 cross member 107 are joined to the tunnel reinforcement 109 and the side sill 95, respectively.

As shown in FIG. 27, a closed-section portion 115 is formed by the No. 2.5 cross member 107 and the floor panel 105, and a seat-rail attaching member 114 to attach the seat rail 112 is arranged on an upper face 107c of the No. 2.5 cross member 107. This seat-rail attaching member 114 has substantially a square-shaped section and its both-side end portions, in the vehicle width direction, is joined to the tunnel reinforcement 109 and the No. 2.5 cross member 107. The seat-rail attaching member 114 includes a bolt through hole 114b into which a bolt for seat-belt attachment BT is inserted and a nut NT which is welded thereto to be fastened to the bolt BT. The seat rail 112 is fixed to the seat-rail attaching member 114 with the bolt BT and the nut NT.

A bulkhead 160 as a first reinforcing member is provided in the closed-section portion 115 formed by the No. 2.5 cross member 107 and the floor panel 105 at a specified position on an inner face of the No. 2.5 cross member 107 which is located in the vicinity of a portion where the seat-rail attaching member 114 is joined to the No. 2.5 cross member 107. A pair of bulkheads 170 as a second reinforcing member is provided in a closed-section portion 116 formed by the protrusion 109a of the tunnel reinforcement 109 and the floor panel 105 at a specified position on the inner face of the floor panel 105 which is located in the vicinity of a portion where the No. 2.5 cross member 107 is joined to the floor panel 105. The bulkheads 170 are located away from each other in the vehicle longitudinal direction.

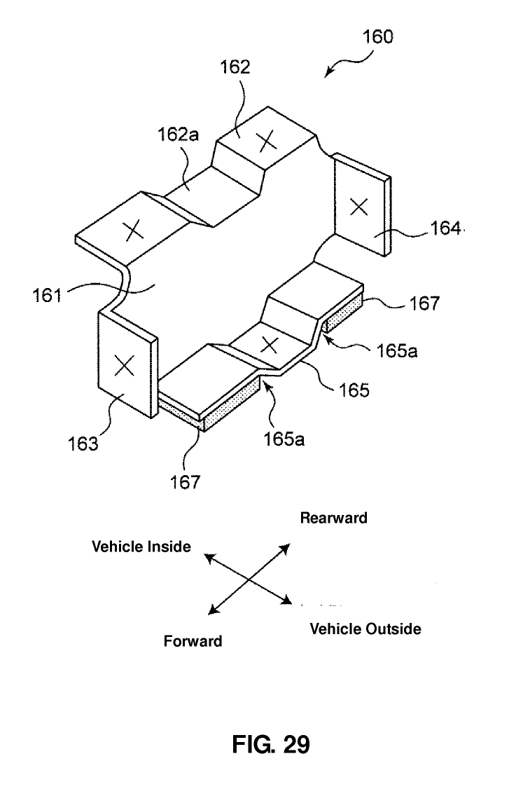

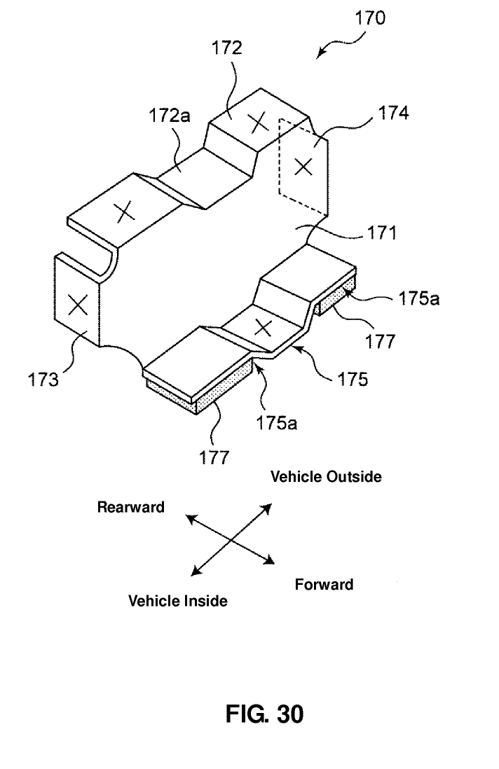

FIG. 29 is a perspective view showing the bulkhead as the first reinforcing member according to the seventh embodiment of the present invention, and FIG. 30 is a perspective view showing the bulkhead as the second reinforcing member according to the seventh embodiment of the present invention. Herein, a state in which the damping member is attached to the bulkhead is illustrated in FIGS. 29 and 30.

The bulkhead 160 comprises, as shown in FIG. 29, a partition face portion 161 as a partition wall portion which partitions the closed-section portion 115, a first flange portion 162 which is provided at an upper side portion of the partition face portion 161 and extends toward the vehicle inside, a second flange portion 163 which is provided at a forward side portion of the partition face portion 161 and extends toward the vehicle outside, a third flange portion 164 which is provided at a rearward side portion of the partition face portion 161 and extends toward the vehicle outside, and a fourth flange portion 165 which is provided at a lower side portion of the partition face portion 161 and extends toward the vehicle outside.

A groove portion 162a is formed at the first flange portion 162 of the bulkhead 160, which corresponds to a groove portion 107a which is provided at an upper face portion 107c of the No. 2.5 cross member 107 and extends in the vehicle width direction. Seat portions 165a to place viscoelastic members 167 thereon, which will be described, are formed at the fourth flange portion 165.

The first flange portion 162 of the bulkhead 160 is joined to the upper face portion 107c of the No. 2.5 cross member 107 by spot welding, and the second and third flange portions 163, 164 of the bulkhead 160 are joined to a side face portion 107d of the No. 2.5 cross member 107 by spot welding.

Further, the fourth flange portion 165 of the bulkhead 160 is joined to the floor panel 105 by spot welding, and the viscoelastic members 167 as the vibration damping member which are placed and adheres onto the seat portions 165a of the fourth flange portion 165 are made adhere to the floor panel 105. Thus, the fourth flange portion 165 is joined to the floor panel 105 via the viscoelastic members 167.

As shown in FIG. 27, the bulkhead 160 is provided such that a vertical face portion 114a of the seat-rail attaching member 114 and the partition face portion 161 are substantially continuous and the side face portion 109b of the protrusion portion 109a of the tunnel reinforcement 109 and the partition face portion 161 are substantially continuous.

In a state in which the bulkhead 160 is provided in the closed-section portion 115 formed by the No. 2.5 cross member 107 and the floor panel 105, the spot-welding joint portions of the bulkhead 160 to the frame comprised of the No. 2.5 cross member 107 and the floor panel 105 constitute the rigid joint portions. Meanwhile, the joint portions via the viscoelastic members constitute the flexible joint portions. In FIG. 29, the spot-welding portions of the bulkhead 160 are shown by x marks.

FIG. 30 shows the front-side bulkhead 170 provided on the front side in the closed-section portion 116. As shown in FIG. 30, the bulkhead 170 comprises a partition face portion 171 as a partition wall portion which partitions the closed-section portion 116, a first flange portion 172 which is provided at an upper side portion of the partition face portion 171 and extends rearward, a second flange portion 173 which is provided at a vehicle-inside side portion of the partition face portion 171 and extends rearward, a third flange portion 174 which is provided at a vehicle-outside side portion of the partition face portion 171 and extends rearward, and a fourth flange portion 175 which is provided at a lower side portion of the partition face portion 171 and extends toward forward.

A groove portion 172a is formed at the first flange portion 172 of the bulkhead 170, which corresponds to a groove portion 105a which is provided at a vehicle-inside end portion of the floor panel 105 and extends in the vehicle longitudinal direction. Seat portions 175a to place viscoelastic members 177 thereon, which will be described, are formed at the fourth flange portion 175.

The first flange portion 172 of the bulkhead 170 is joined to the floor panel 105 by spot welding, and the second and third flange portions 173, 174 of the bulkhead 170 are respectively joined to the vehicle-inside side face portion 109b and the vehicle-outside side face portion 109b of the protrusion portion 109a of the tunnel reinforcement 109 by spot welding.

Further, the fourth flange portion 175 of the bulkhead 170 is joined to a lower face portion 109c of the protrusion portion 109a of the tunnel reinforcement 109 by spot welding, and the viscoelastic members 177 as the vibration damping members which are placed and adheres onto the seat portions 175a of the fourth flange portion 175 are made adhere to the above-described lower face portion 109c. Thus, the fourth flange portion 175 is joined to the tunnel reinforcement 109 via the viscoelastic members 177.

In a state in which the bulkhead 170 is provided in the closed-section portion 116 formed by the floor panel 105 and the tunnel reinforcement 109, the spot-welding joint portions of the bulkhead 170 to the frame comprised of the floor panel 105 and the tunnel reinforcement 109 constitute the rigid joint portions. Meanwhile, the joint portions via the viscoelastic members constitute the flexible joint portions. In FIG. 30, the spot-welding portions of the bulkhead 170 are shown by x marks.

The rear-side bulkhead 170 provided on the rear side in the closed-section portion 116 is formed similarly to the above-described front-side bulkhead 170, but symmetrically in the vehicle longitudinal direction. These front-side and rear-side bulkheads 170 are arranged, as shown in FIG. 28B, such that their partition portions 171 and the side face portion 107b of the No. 2.5 cross member 107 are continuous substantially straightly in the vehicle vertical direction.

Herein, the sheet-shaped viscoelastic members 177 are made adhere to the seat portions 175a of the fourth flange portion 175 of the bulkheads 170, these bulkheads 170 are arranged in the tunnel reinforcement 109 to which the funnel frame 113 is joined, corresponding to a portion where the No. 2.5 cross member 107 is provided, and the second flange portions 173, the third flange portions 174, and the fourth flange portions 175 are respectively joined to the tunnel reinforcement 109. Then, the first flange portions 172 are joined to the floor panel 105. Thus, the bulkheads 170 are attached in the closed-section portion 116.

Further, the viscoelastic members 167 are made adhere to the seat portions 165a of the fourth flange portion 165 of the bulkhead 160, this bulkhead 160 is arranged in the No. 2.5 cross member 107, corresponding to a portion where the seat-rail attaching member 114 is provided, and the first flange portion 162, the second flange portion 163, and the third flange portion 164 are respectively joined to the No. 2.5 cross member 107. Then, the flange portion 107a of the No. 2.5 cross member 107 is joined to the floor panel 105, and the flange portion 107b of the No. 2.5 cross member 107 is joined to the tunnel reinforcement 109. Then, the fourth flange portion 165 is joined to the floor panel 105. Thus, the bulkhead 160 is attached in the closed-section portion 115. Then, the seat-rail attaching member 114 is joined onto the outer face of the No. 2.5 cross member 107.

According to the vehicle-body structure of a vehicle according to the seventh embodiment of the present invention, since the bulkhead 160 is rigidly joined to the No. 2.5 cross member 107 and the floor panel 105 and flexibly joined to the floor panel 105 via the viscoelastic members 167, the bulkhead 160 can be firmly joined to the frame formed by the No. 2.5 cross member 107 and the floor panel 105 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the No. 2.5 cross member 107 and the floor panel 105 to the bulkhead 160 are provided at a specified position on an inner face of the frame which is located in the vicinity of a portion where the seat-rail attaching member 114 is joined to the frame, vibrations inputted to the frame from the seat-rail attaching member 114 can be reduced effectively.

Moreover, since the bulkheads 170 are rigidly joined to the floor panel 105 and the tunnel reinforcement 109 and flexibly joined to the tunnel reinforcement 109 via the viscoelastic members 177, the bulkheads 170 can be firmly joined to the frame formed by the floor panel 105 and the tunnel reinforcement 109 with the rigid joint portions, thereby providing the rigid-improvement effect, and the vibration of the above-described frame can be reduced with the flexible joint portion, thereby restraining the vibration transmission to passengers in the vehicle compartment.

Also, since the joint portions of the frame comprised of the floor panel 105 and the tunnel reinforcement 109 to the bulkhead 170 are provided at a specified position on an inner face of the frame which is located in the vicinity of a portion where the No. 2.5 cross member 107 is joined to the frame, vibrations inputted to the frame from the No. 2.5 cross member 107 can be reduced effectively.

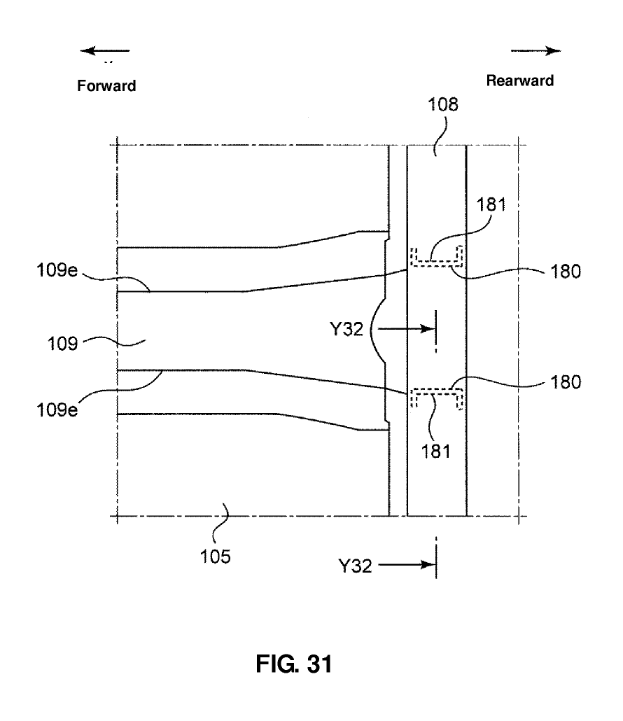

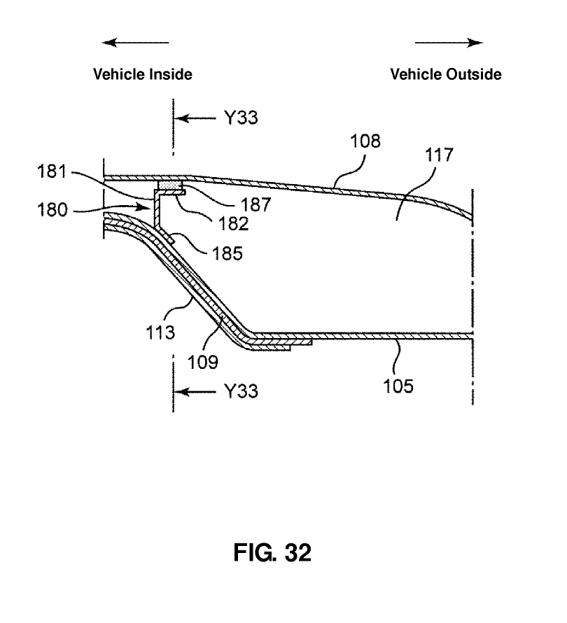

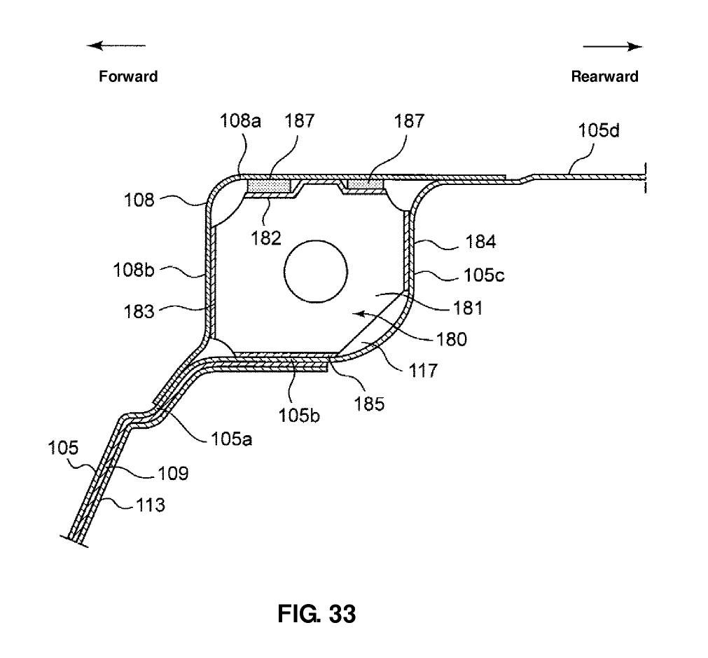

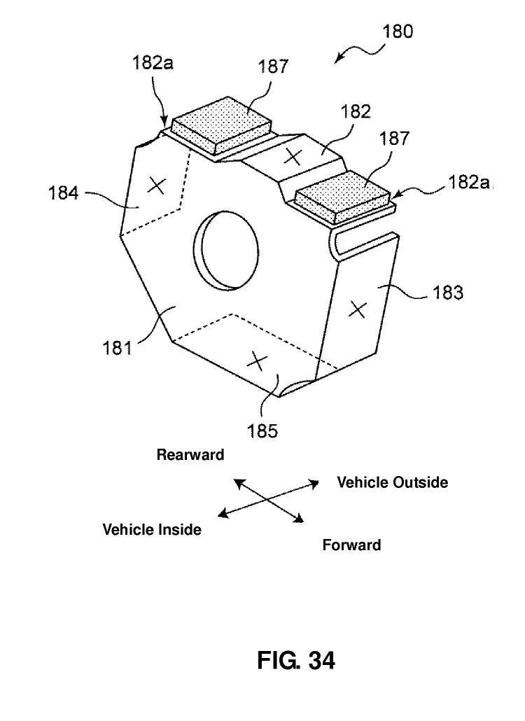

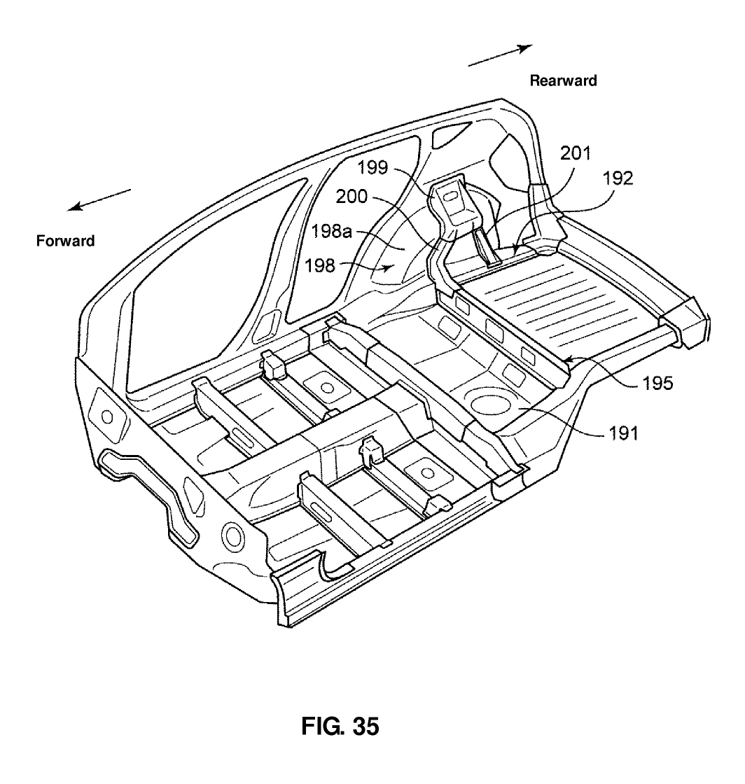

A vehicle-body structure of a vehicle according to the eighth embodiment of the present invention will be described referring to FIGS. 31 through 34. FIG. 31 is an enlarged view of a third major part of FIG. 16, FIG. 32 is a sectional view taken along line Y32-Y32 of FIG. 31, FIG. 33 is a sectional view taken along line Y33-Y33 of FIG. 32, and FIG. 34 is a perspective view showing a bulkhead as the reinforcing member according to the eighth embodiment of the present invention. Herein, FIG. 34 shows a state in which a damping member is attached to the bulkhead.

As shown in FIG. 31, the No. 3 cross member 108 provided onto the upper face of the floor panel 105 is arranged substantially perpendicularly to the tunnel reinforcement 109 extending longitudinally. This No. 3 cross member 108 comprises a horizontal face portion 108a and a vertical face portion 108b and has substantially a square section as shown in FIG. 33.

The floor panel 105 comprises a slant face portion 105a which slants obliquely upward and rearward, a first horizontal face portion 105b which extends rearward from an upper end portion of the slant face portion 105a, a vertical face portion 105c which extends upward from a rear end portion of the first horizontal face portion 105b, and a second horizontal face portion 105d which extends rearward from an upper end portion of the vertical face portion 105c.

The slant face portion 105a of the floor panel 105 and a front end portion of the No. 3 cross member 108 are joined, and the second horizontal face portion 105d of the floor panel 105 and a rear end portion of the No. 3 cross member 108 are joined, so that a closed-section portion 117 is formed by the No. 3 cross member 108 and the floor panel 105. Further, the tunnel reinforcement 109 and a rear end portion of the tunnel frame 113 are joined to the first horizontal face portion 105b of the floor panel 105 on an outer face of the closed-section portion 117.

According to the present embodiment, a pair of bulkheads 180 as the reinforcing member is provided in the closed-section portion 117 formed by the No. 3 cross member 108 and the floor panel 105 at a specified position on the inner face of the floor panel 105 which is located in the vicinity of a portion where the tunnel reinforcement 109 and the tunnel frame 113 are joined to the floor panel 105. The bulkheads 180 are located away from each other in the vehicle width direction.

FIG. 34 shows the left-side bulkhead 180 provided on the left side in the closed-section portion 117. As shown in FIG. 34, the bulkhead 180 comprises a partition face portion 181 as a partition wall portion which partitions the closed-section portion 117, a first flange portion 182 which is provided at an upper side portion of the partition face portion 181 and extends toward the vehicle outside, a second flange portion 183 which is provided at a forward side portion of the partition face portion 181 and extends toward the vehicle outside, a third flange portion 184 which is provided at a rearward side portion of the partition face portion 181 and extends toward the vehicle outside, and a fourth flange portion 185 which is provided at a lower side portion of the partition face portion 181 and extends toward the vehicle outside. Seat portions 182a to place viscoelastic members 187 thereon, which will be described, are formed at the first flange portion 182.

The third flange portion 184 of the bulkhead 180 is joined to the vertical face portion 105c of the floor panel 105 by spot welding, and the fourth flange portion 185 of the bulkhead 180 is joined to the first horizontal face portion 105b of the floor panel 105 by spot welding. Further, the second flange portion 183 of the bulkhead 180 is joined to the vertical face portion 108b of the No. 3 cross member 108 by spot welding.

Further, the first flange portion 182 of the bulkhead 180 is joined to the horizontal face portion 108a of the No. 3 cross member 108 by spot welding, and the viscoelastic members 187 as the vibration damping members which are placed and adheres onto the seat portions 182a of the first flange portion 182 are made adhere to the horizontal face portion 108a of the No. 3 cross member 108. Thus, the first flange portion 182 is joined to the No. 3 cross member 108 via the viscoelastic members 187.

In a state in which the bulkhead 180 is provided in the closed-section portion 117 formed by the No. 3 cross member 108 and the floor panel 105, the spot-welding joint portions of the bulkhead 180 to the frame comprised of the No. 3 cross member 108 and the floor panel 105 constitute the rigid joint portions. Meanwhile, the joint portions via the viscoelastic members constitute the flexible joint portions. In FIG. 34, the spot-welding portions of the bulkhead 180 are shown by x marks.

The right-side bulkhead 180 provided on the right side in the closed-section portion 117 is formed similarly to the above-described left-side bulkhead 180, but symmetrically in the vehicle width direction. These left-side and right-side bulkheads 180 are arranged, as shown in FIG. 31, such that their partition portions 181 and a side face portion 109e of the tunnel reinforcement 109 are continuous substantially straightly.

Herein, the sheet-shaped viscoelastic members 187 are made adhere to the seat portions 182a of the bulkheads 180, these bulkheads 180 are arranged at the floor panel 105, corresponding to a portion where the tunnel reinforcement 109 and the tunnel frame 113 are provided, and the third flange portions 184 and the fourth flange portions 185 are respectively joined to the floor panel 105 to which the tunnel reinforcement 109 and the tunnel frame 113 are joined. Then, the first flange portions 182 and the second flange portion 185 are joined to the No. 3 cross member 108. Thus, the bulkheads 180 are attached in the closed-section portion 117.

According to the vehicle-body structure of a vehicle according to the eighth embodiment of the present invention, since the bulkheads 180 are rigidly joined to the No. 3 cross member 108 and the floor panel 105 and flexibly joined to the No. 3 cross member 108 via the viscoelastic members 187, the bulkheads 180 can be firmly joined to the frame formed by the No. 3 cross member 108 and the floor panel 105 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the No. 3 cross member 108 and the floor panel 105 to the bulkheads 180 are provided at a specified position on an inner face of the frame which is located in the vicinity of a portion where the tunnel reinforcement 109 and the tunnel frame 113 are joined to the frame, vibrations inputted to the frame from the tunnel reinforcement 109 and the tunnel frame 113 can be reduced effectively.

FIG. 35 is a view showing a rear portion of the vehicle body to which a vehicle-body structure of a vehicle according to ninth and tenth embodiments of the present invention is applied. There are provided, as members constituting the rear portion of the vehicle body to which the vehicle-body structure according to the ninth and tenth embodiments of the present invention is applied, a floor panel 191 which constitutes the floor face of the vehicle body, a pair of rear side frames 192 which extends in the vehicle longitudinal direction at both-side end portions of the floor panel 191, a No. 4 cross member 195 which extends in the vehicle width direction on the floor panel 191 and interconnects the pair of rear side frames 192, and a pair of rear wheel houses 198 which accommodates a pair of rear wheels (not illustrated).

The rear wheel house 198 comprises a rear-wheel house inner 198a which protrudes toward the vehicle inside and a rear-wheel house outer (not illustrated) which protrudes toward the vehicle outside. A suspension housing 199 to support a suspension (not illustrated) is attached to the rear-wheel house inner 198a.

First and second side brace members 200, 201 which extend downward respectively from front and rear sides of the suspension housing 199 and have a U-shaped section are attached to the rear-wheel house inner 198a. The first side brace member 200 is joined to the rear side frame 199 and the No. 4 cross member 195 and arranged substantially straightly with the No. 4 cross member 195. The second side brace member 201 is joined to the rear side frame 192 in back of the first side brace member 200.

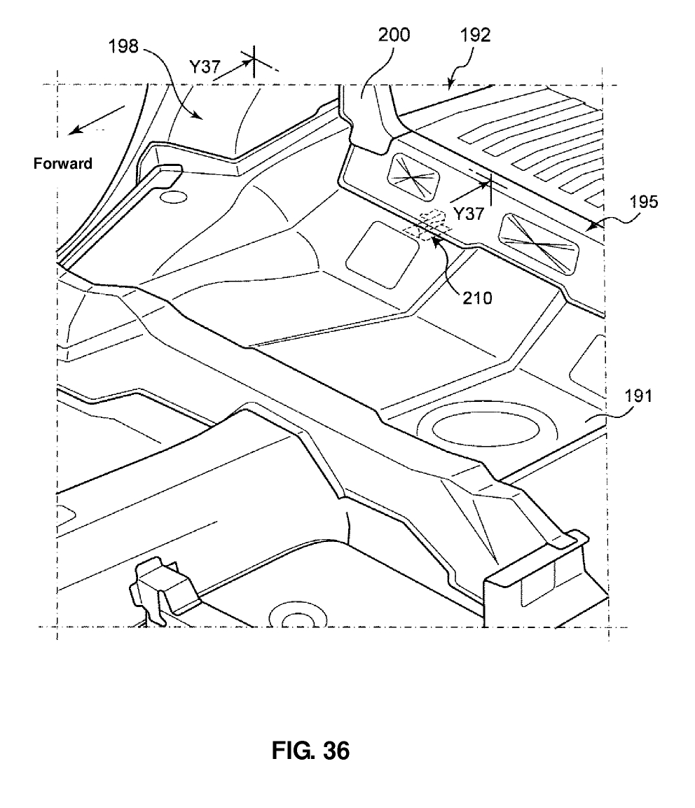

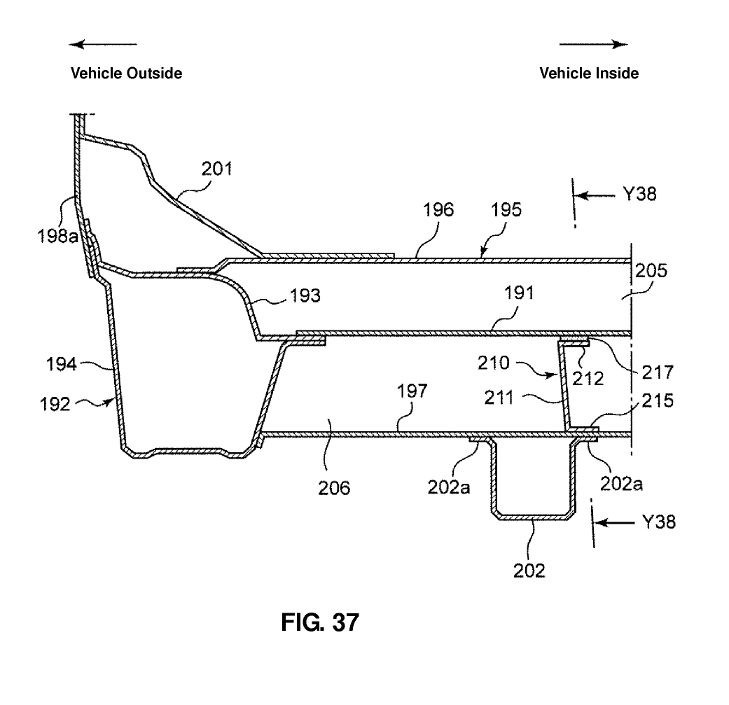

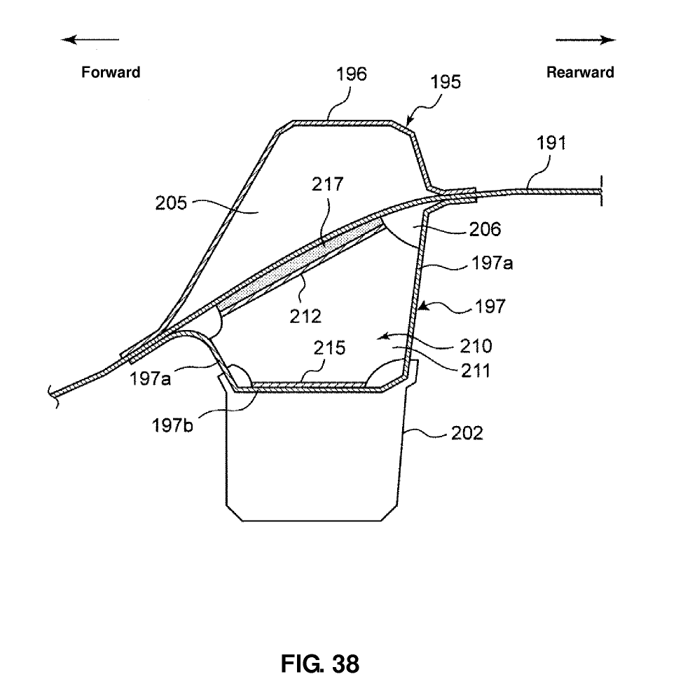

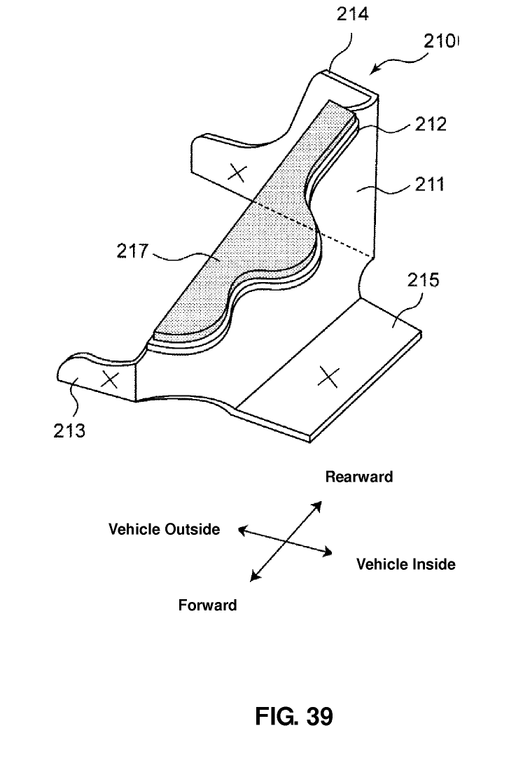

The vehicle-body structure of a vehicle according to the ninth embodiment of the present invention will be described referring to FIGS. 36 through 39. FIG. 36 is an enlarged view of a major part of FIG. 35, FIG. 37 is a sectional view taken along line Y37-Y37 of FIG. 36, FIG. 38 is a sectional view taken along line Y38-Y38 of FIG. 37, and FIG. 39 is a perspective view showing a bulkhead as the reinforcing member according to the ninth embodiment of the present invention. Herein, FIG. 39 shows a state in which a damping member is attached to the bulkhead.

As shown in FIG. 36, a lower end portion of the first side brace member 200 is joined to an outer face of a vehicle-outside end portion of the No. 4 cross member 195, so that vibrations from the first side brace member 200 is transmitted to the No. 4 cross member 195. The No. 4 cross member 195 comprises, as shown in FIG. 38, a No. 4-cross-member upper 196 which constitutes an upper side thereof and has a U-shaped section and a No. 4-cross-member lower 197 which constitutes a lower side thereof and has a U-shaped section.

The No. 4-cross-member upper 196 is joined to an upper face of the floor panel 191 at a side end portion thereof in the vehicle longitudinal direction, thereby forming a closed-section portion 205 together with the floor panel 191. The No. 4-cross-member upper 196 is also joined to a rear-side-frame upper 193 which forms an upper face portion of the rear side frame 192.

The No. 4-cross-member lower 197 is joined to a lower face of the floor panel 191 at the side end portion thereof in the vehicle longitudinal direction, thereby forming a closed-section portion 206 together with the floor panel 191. The No. 4-cross-member lower 197 is also joined to a rear-side-frame lower 194 which forms a lower face portion and a side face portion of the rear side frame 192.

The rear side frame 192 is formed to have a closed shape by the rear-side-frame upper 193 and the rear-side-frame lower 194 having a U-shaped section, and the rear-side-frame upper 193 covers over the rear-side-frame lower 194. The rear-side-frame upper 193 and the rear-side-frame lower 194 are respectively joined to the rear-wheel house inner 198a and the floor panel 191.

As shown in FIGS. 37 and 38, a tank attaching member 202 for a fuel tank (not illustrated) is attached to a lower face portion of the No. 4-cross-member lower 197. The tank attaching member 202 is formed in a box shape, and flange portions 202a which are formed at its upper end portions are joined to the lower face portion and the side face portion of the No. 4-cross-member lower 197. Thereby, vibrations from the tank attaching member 202 are transmitted to the No. 4 cross member 195.

According to the present embodiment, a bulkhead 210 as the reinforcing member is provided in the closed-section portion 206 formed by the No. 4-cross-member lower 197 and the floor panel 191 at a specified position on the inner face of the No. 4-cross-member lower 197 which is located in the vicinity of a portion where the tank attaching member 202 is joined to the No. 4-cross-member lower 197.

As shown in FIG. 39, the bulkhead 210 comprises a partition face portion 211 as a partition wall portion which partitions the closed-section portion 206, a first flange portion 212 which is provided at an upper side portion of the partition face portion 211 and extends toward the vehicle inside, a second flange portion 213 which is provided at a forward side portion of the partition face portion 211 and extends toward the vehicle outside, a third flange portion 214 which is provided at a rearward side portion of the partition face portion 211 and extends toward the vehicle outside, and a fourth flange portion 215 which is provided at a lower side portion of the partition face portion 211 and extends toward the vehicle inside.

The second, third and fourth flange portions 213, 214, 215 of the bulkhead 210 are respectively joined to a forward side face portion 197a, a bottom face portion 197b, and a rearward side face portion 197a of the No. 4-cross-member lower 197 by spot welding. Further, the first flange portion 212 of the bulkhead 210 faces to a lower face of the floor panel 191, and a viscoelastic member 217 as the vibration damping member which is placed and adheres onto the first flange portion 212 is made adhere to the lower face of the floor panel 191. Thus, the first flange portion 212 is joined to the floor panel 191 via the viscoelastic member 217.

Herein, the sheet-shaped viscoelastic member 217 is made adhere to the first flange portion 212 of the bulkheads 210, the bulkhead 210 is arranged in the No. 4-cross-member lower 197, corresponding to a portion where the tank attaching member 202 is provided, and the second flange portion 213, the third flange portion 214, and the fourth flange portion 215 are respectively joined to the No. 4-cross-member lower 197. Then, front and rear side end portions of the No. 4-cross-member lower 197 are joined to the lower face of the floor panel 191. Thus, the bulkhead 210 is attached in the closed-section portion 206. After this, the tank attaching member 202 is joined to the outer face of the No. 4-cross-member lower 197.

In a state in which the bulkhead 210 is provided in the closed-section portion 206 formed by the No. 4-cross-member lower 197 and the floor panel 191, the spot-welding joint portions of the bulkhead 210 to the frame comprised of the No. 4-cross-member lower 197 and the floor panel 191 constitute the rigid joint portions. Meanwhile, the joint portion via the viscoelastic member constitutes the flexible joint portion. In FIG. 39, the spot-welding portions of the bulkhead 210 are shown by x marks.

According to the vehicle-body structure of a vehicle according to the ninth embodiment of the present invention, since the bulkhead 210 is rigidly joined to the No. 4-cross-member lower 197 and flexibly joined to the floor panel 191 via the viscoelastic member 217, the bulkhead 210 can be firmly joined to the frame formed by the No. 4-cross-member lower 197 and the floor panel 191 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the No. 4-cross-member lower 197 and the floor panel 191 to the bulkhead 210 are provided at a specified position on an inner face of the frame which is located in the vicinity of a portion where the tank attaching member 202 is joined to the frame, vibrations inputted to the frame from the tank attaching member 202 can be reduced effectively.

While the viscoelastic member 217 is provided over a whole area of the first flange portion 212 of the bulkhead 210 in the present embodiment, a seat portion to place the viscoelastic member 217 thereon may be formed partially at the first flange portion 212 so that the floor panel 191 and another part of the first flange portion 212 than the above-described seat portion are joined by spot welding and the floor panel 191 and the first flange portion 212 are flexibly joined via the viscoelastic member 217 placed on the seat portion. Thus, the rigid joint portions and the flexible joint portion may be provided at the first flange portion 212 of the bulkhead 210.

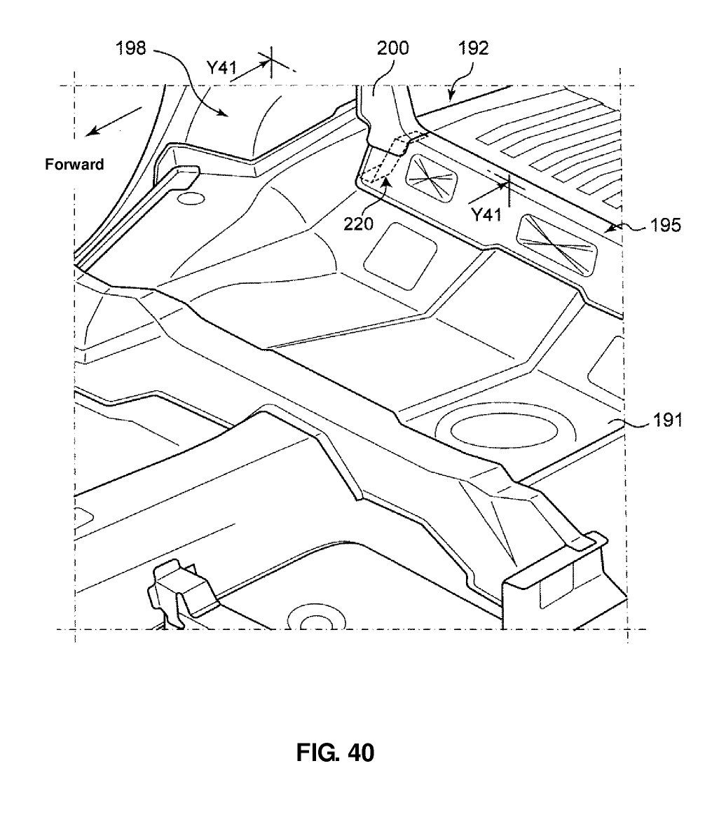

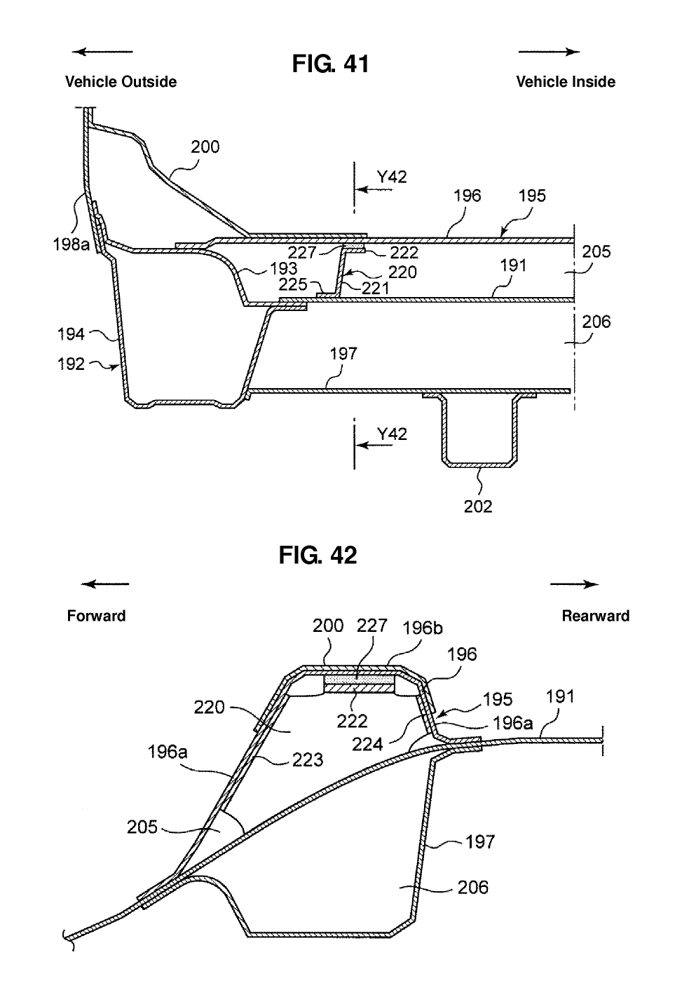

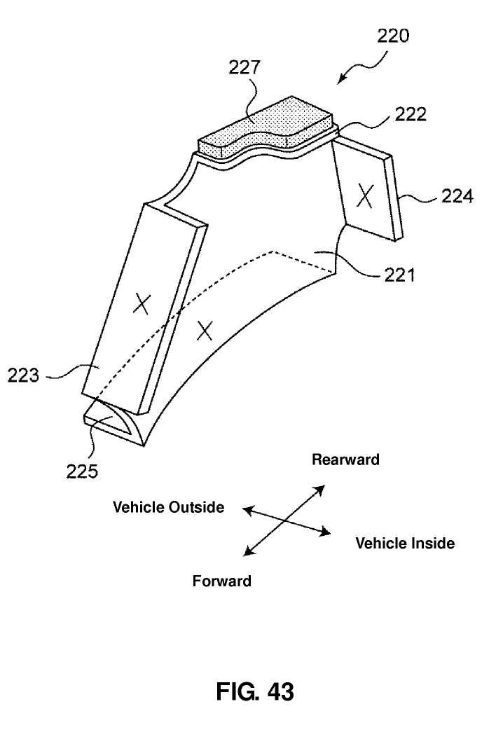

The vehicle-body structure of a vehicle according to the tenth embodiment of the present invention will be described referring to FIGS. 40 through 43. FIG. 40 is an enlarged view of a major part of FIG. 35, FIG. 41 is a sectional view taken along line Y41-Y41 of FIG. 40, FIG. 42 is a sectional view taken along line Y42-Y42 of FIG. 41, and FIG. 43 is a perspective view showing a bulkhead as the reinforcing member according to the tenth embodiment of the present invention. Herein, FIG. 43 shows a state in which a damping member is attached to the bulkhead.

As shown in FIGS. 40 through 42, while the vehicle-body structure of a vehicle according to the tenth embodiment of the present invention is constituted substantially similarly to that according to the above-described ninth embodiment, the bulkhead as the reinforcing member is arranged in the closed-section portion 205 formed by the No. 4-cross-member upper 196 and the floor panel 191. A description of the structures of the tenth embodiment which is the same as those of the ninth embodiment is omitted here.

According to the present embodiment, a bulkhead 220 as the reinforcing member is provided in the closed-section portion 205 formed by the No. 4-cross-member upper 196 and the floor panel 191 at a specified position on the inner face of the No. 4-cross-member upper 196 which is located in the vicinity of a portion where the first side brace member 200 is joined to the No. 4-cross-member upper 196.

As shown in FIG. 43, the bulkhead 220 comprises a partition face portion 221 as a partition wall portion which partitions the closed-section portion 205, a first flange portion 222 which is provided at an upper side portion of the partition face portion 221 and extends toward the vehicle inside, a second flange portion 223 which is provided at a forward side portion of the partition face portion 221 and extends toward the vehicle inside, a third flange portion 224 which is provided at a rearward side portion of the partition face portion 221 and extends toward the vehicle inside, and a fourth flange portion 225 which is provided at a lower side portion of the partition face portion 221 and extends toward the vehicle outside.

The second and third flange portions 223, 224 of the bulkhead 210 are respectively joined to a forward side face portion 195a and a rearward side face portion 195a of the No. 4-cross-member upper 195 by spot welding, and the fourth flange portion 225 is joined to the upper face of the floor panel 191 by spot welding. Further, the first flange portion 222 of the bulkhead 220 faces to an upper face portion 196b of the No. 4-cross-member upper 196, and a viscoelastic member 227 as the vibration damping member which is placed and adheres onto the first flange portion 222 is made adhere to the No. 4-cross-member upper 196. Thus, the first flange portion 222 is joined to the No. 4-cross-member upper 196 via the viscoelastic member 227.

Herein, the sheet-shaped viscoelastic member 227 is made adhere to the first flange portion 222 of the bulkheads 220, the bulkhead 220 is arranged in the No. 4-cross-member upper 196, corresponding to a portion where the first side brace member 200 is provided, and the second flange portion 223 and the third flange portion 224 are respectively joined to the No. 4-cross-member upper 196. Then, front and rear side end portions of the No. 4-cross-member upper 196 are joined to the upper face of the floor panel 191, and the fourth flange portion 225 is joined to the upper face of the floor panel 191. Thus, the bulkhead 220 is attached in the closed-section portion 205. After this, the first side brace member 200 is joined to the outer face of the No. 4-cross-member upper 196.

In a state in which the bulkhead 220 is provided in the closed-section portion 205 formed by the No. 4-cross-member upper 196 and the floor panel 191, the spot-welding joint portions of the bulkhead 220 to the frame comprised of the No. 4-cross-member upper 196 and the floor panel 191 constitute the rigid joint portions. Meanwhile, the joint portion via the viscoelastic member constitutes the flexible joint portion. In FIG. 43, the spot-welding portions of the bulkhead 220 are shown by x marks.

According to the vehicle-body structure of a vehicle according to the tenth embodiment of the present invention, since the bulkhead 220 is rigidly joined to the No. 4-cross-member upper 196 and the floor panel 191 and flexibly joined to the No. 4-cross-member upper 196 via the viscoelastic member 227, the bulkhead 220 can be firmly joined to the frame formed by the No. 4-cross-member upper 196 and the floor panel 191 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the No. 4-cross-member upper 196 and the floor panel 191 to the bulkhead 220 are provided at a specified position on an inner face of the frame which is located in the vicinity of a portion where the first side brace member 200 is joined to the frame, vibrations inputted to the frame from the tank attaching member 202 can be reduced effectively.

While the viscoelastic member 227 is provided over a whole area of the first flange portion 222 of the bulkhead 220 in the present embodiment, a seat portion to place the viscoelastic member 227 thereon may be formed partially at the first flange portion 222 so that the floor panel 191 and another part of the first flange portion 222 than the above-described seat portion are joined by spot welding and the floor panel 191 and the first flange portion 222 are flexibly joined via the viscoelastic member 227 placed on the seat portion. Thus, the rigid joint portions and the flexible joint portion may be provided at the first flange portion 222 of the bulkhead 220.

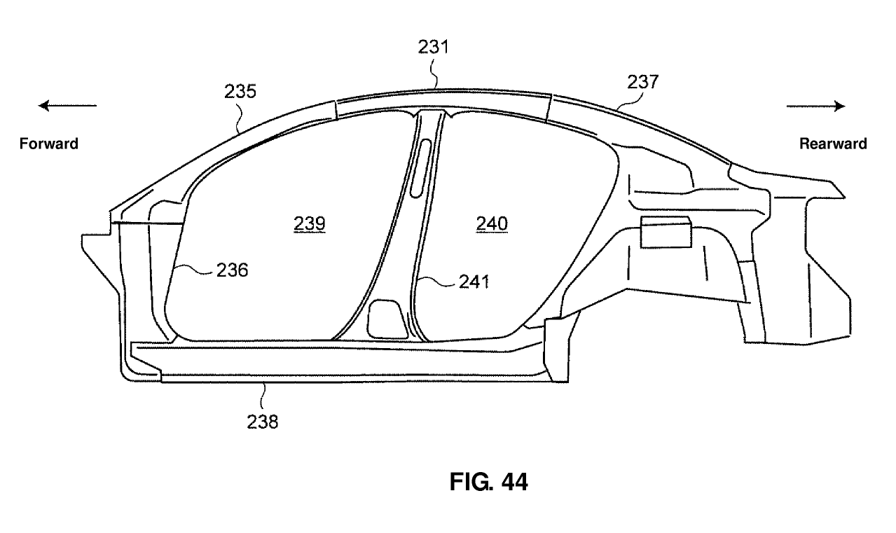

FIG. 44 is a view showing a side portion of the vehicle body to which a vehicle-body structure of a vehicle according to an eleventh embodiment of the present invention is applied. As shown in FIG. 44, there are provided, as members constituting the side portion of the vehicle body to which the vehicle-body structure according to the eleventh embodiment of the present invention is applied, a roof rail 231 which extends in the vehicle longitudinal direction at an upper portion of the vehicle body, a front pillar 235 which extends forward from a front end portion of the roof rail 231, a hinge pillar 236 which extends downward from a front end portion of the front pillar 235, a rear pillar 237 which extends rearward from a rear end portion of the roof rail 231 and a rear-side portion of which extends downward, a side sill 238 which extends in the vehicle longitudinal direction at a lower portion of the vehicle body and is joined to the hinge pillar 236 and the rear pillar 237, and a center pillar 241 which extends vertically between a front door opening portion 239 and a rear door opening portion 240 and is joined to the roof rail 231 and the side sill 238.

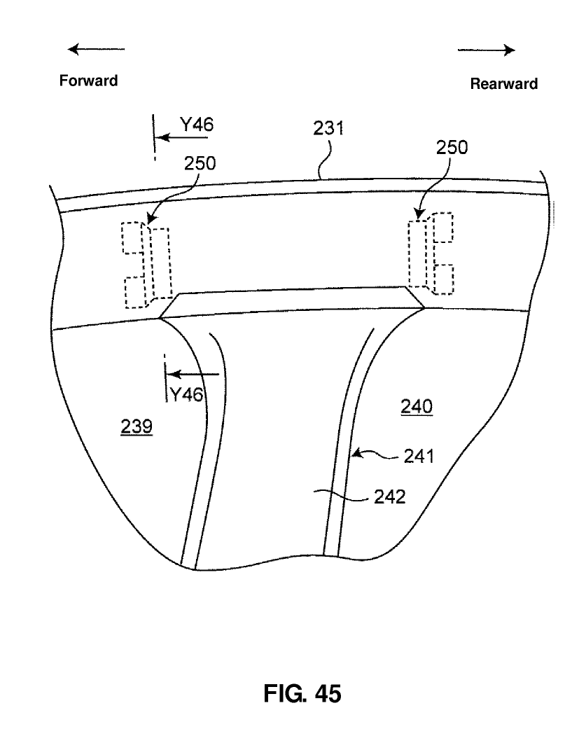

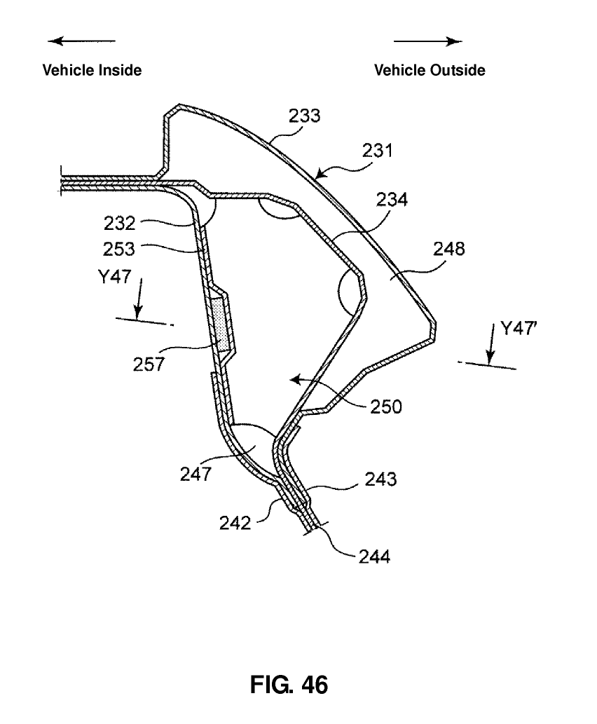

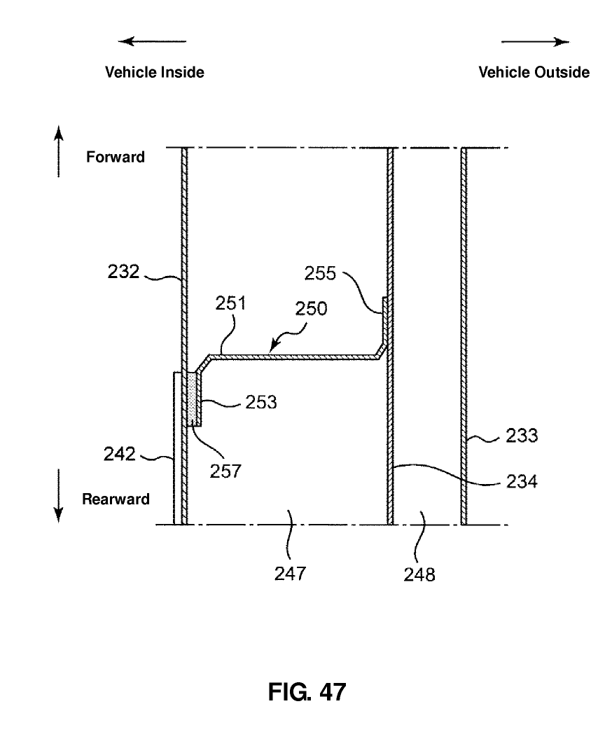

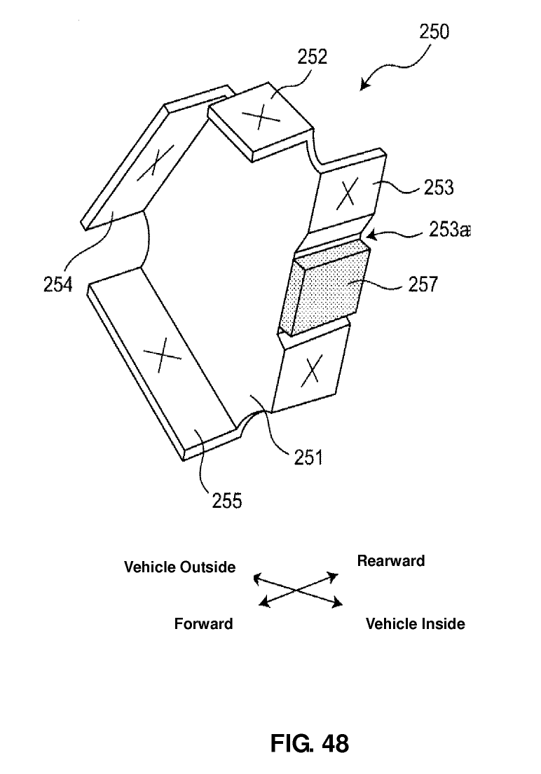

FIG. 45 is an enlarged view of a major part of FIG. 44, FIG. 46 is a sectional view taken along line Y46-Y46 of FIG. 45, FIG. 47 is a sectional view taken along line Y47-Y47 of FIG. 46, and FIG. 48 is a perspective view showing a bulkhead as the reinforcing member according to the eleventh embodiment of the present invention. Herein, FIG. 48 shows a state in which a damping member is attached to the bulkhead.

As shown in FIG. 45, the roof rail 231 is joined to the center pillar 241 substantially perpendicularly. The roof rail 231 comprises, as shown in FIG. 46, a roof rail inner 232 which forms a vehicle-body inside of the roof rail 231, a roof rail outer 233 which forms a vehicle-body outside of the roof rail 231, and a roof rail reinforcement 234 which is arranged between the roof rail inner 232 and the roof rail outer 233. Respective inside and lower end portions of these members 232, 233, 234 are joined together.

Thus, a closed-section portion 247 of the roof rail 231 is formed by the roof rail inner 232 and the roof rail reinforcement 234, and a closed-section portion 248 of the roof rail 231 is formed by the roof rail outer 233 and the roof rail reinforcement 234.

The center pillar 241 joined to the roof rail 231 comprises a center pillar inner 242 which forms a vehicle-body inside of the center pillar 241, a center pillar outer 243 which forms a vehicle-body outside of the center pillar 241, and center pillar inner 242 which is arranged between the center pillar inner 242 and the center pillar outer 243. An upper end portion of the center pillar inner 242 is joined to a vehicle inside of the roof rail inner 232, an upper end portion of the center pillar outer 243 is joined to an vehicle outside of the roof rail outer 233, and the center pillar reinforcement 244 is formed integrally with the roof rail reinforcement 234.

According to the present embodiment, a pair of bulkheads 250 as the reinforcing member is provided in the closed-section portion 247 formed by the roof rail inner 232 and the roof rail reinforcement 234 of the roof rail 231 at a specified position on the inner face of the roof rail inner 232 which is located in the vicinity of a portion where the center pillar inner 242 is joined to the roof rail inner 232. The bulkheads 250 are located away from each other in the vehicle longitudinal direction.

FIG. 48 shows the front-side bulkhead 250 provided on the front side in the closed-section portion 247. As shown in FIG. 48, the bulkhead 250 comprises a partition face portion 251 as a partition wall portion which partitions the closed-section portion 247, a first flange portion 252 which is provided at an upper side portion of the partition face portion 251 and extends forward, a second flange portion 253 which is provided at a vehicle-inside side portion of the partition face portion 251 and extends rearward, and third and fourth flange portions 254, 255 which are provided at vehicle-outside side portions of the partition face portion 251 and extends forward. A seat portion 253a is formed at the second flange portion 253 in a recess shape so as to accommodate a viscoelastic member 257 therein, which will be described specifically.

The first, third and fourth flange portions 252, 254, 255 of the bulkhead 250 are respectively joined to the roof rail reinforcement 234 by spot welding. Further, the second flange portion 253 of the bulkhead 250 is joined to the roof rail inner 232 by spot welding, and the viscoelastic member 257 as the vibration damping member which is placed and adheres onto the seat portion 253a of the second flange portion 253 is made adhere to the roof rail inner 232. Thus, the second flange portion 253 is joined to the roof rail inner 232 via the viscoelastic member 257.

In a state in which the bulkhead 250 is provided in the closed-section portion 247 formed by the roof rail inner 232 and the roof rail reinforcement 234, the spot-welding joint portions of the bulkhead 250 to the frame comprised of the roof rail inner 232 and the roof rail reinforcement 234 constitute the rigid joint portions. Meanwhile, the joint portion via the viscoelastic member constitutes the flexible joint portion. In FIG. 48, the spot-welding portions of the bulkhead 250 are shown by x marks.

The rear-side bulkhead 250 provided on the rear side in the closed-section portion 247 is formed similarly to the above-described front-side bulkhead 250, but symmetrically in the vehicle longitudinal direction. These front-side and rear-side bulkheads 250 are respectively provided, as shown in FIG. 45, at specified positions on an inner face of the roof rail 231 which are located in the vicinity of front and rear end portions where the center pillar inner 241 is joined to the roof rail 231.

Herein, the sheet-shaped viscoelastic member 257 is made adhere to the seat portion 253a of the second flange portion 253 of the bulkheads 250, the bulkhead 250 is arranged in the roof rail reinforcement 234, corresponding to a portion where the center pillar inner 242 is provided, and the first flange portion 252, the third flange portion 254, and the fourth flange portion 255 are respectively joined to the roof rail reinforcement 234. Then, respective vehicle-inside and lower end portions of these members 232, 233, 234 are joined together, and the second flange portion 253 is joined to the roof rail inner 232. Thus, the bulkhead 250 is attached in the closed-section portion 247. After this, an upper end portion of the center pillar inner 242 is joined to the vehicle inside of the roof rail inner 232, and an upper end portion of the center pillar outer 243 is joined to the vehicle outside of the roof rail outer 233.

According to the vehicle-body structure of a vehicle according to the eleventh embodiment of the present invention, since the bulkheads 250 are rigidly joined to the roof rail inner 232 and the roof rail reinforcement 234 and flexibly joined to the roof rail inner 232 via the viscoelastic members 257, the bulkheads 250 can be firmly joined to the frame formed by the roof rail inner 232 and the roof rail reinforcement 234 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the roof rail inner 232 and the roof rail reinforcement 234 to the bulkheads 250 are provided at the specified positions on the inner face of the frame which are located in the vicinity of the portions where the center pillar inner 242 is joined to the frame, vibrations inputted to the frame from the center pillar inner 242 can be reduced effectively.

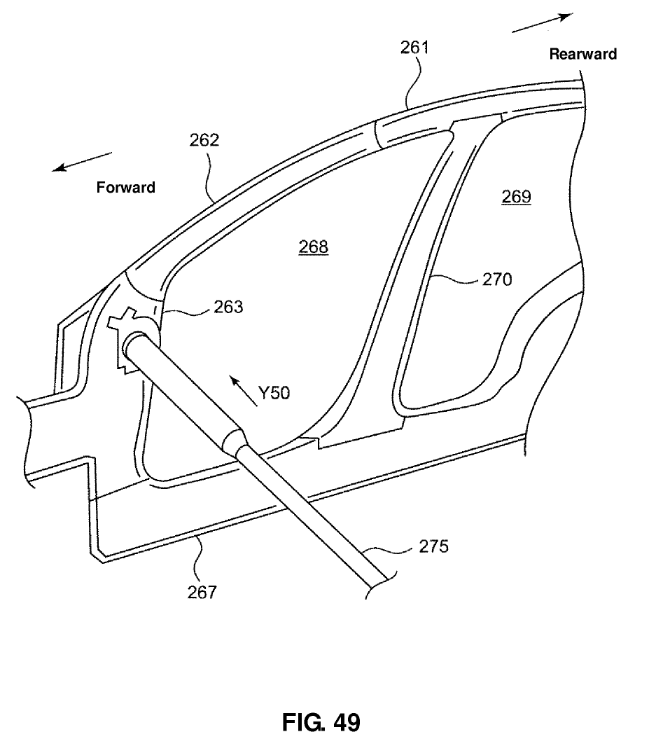

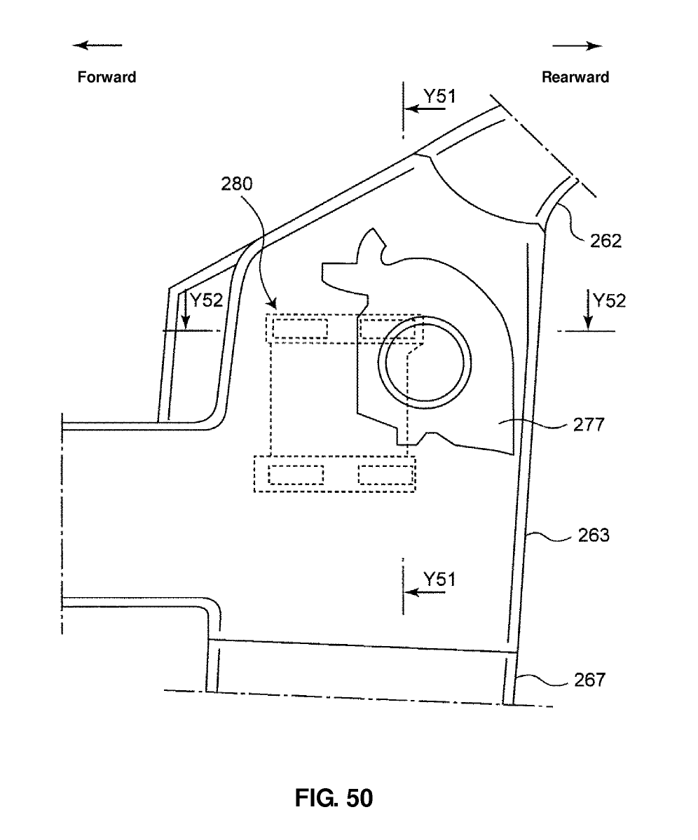

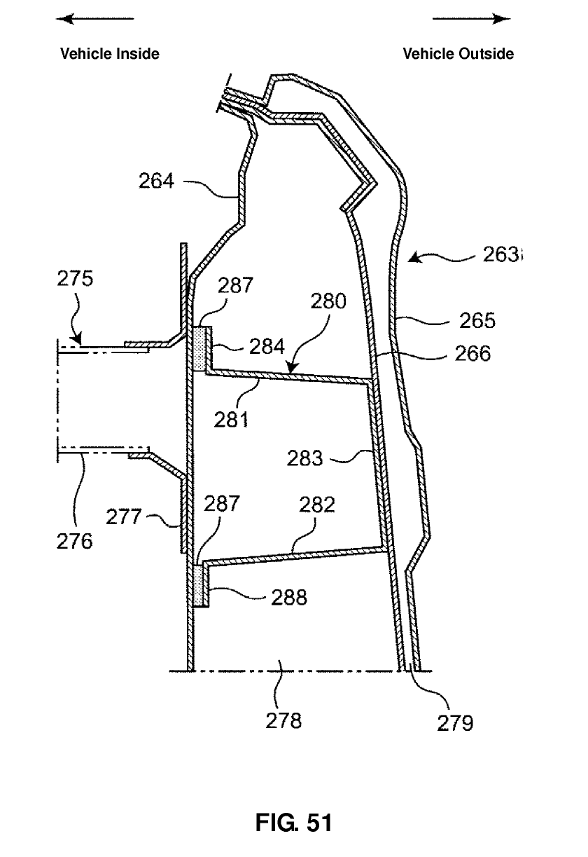

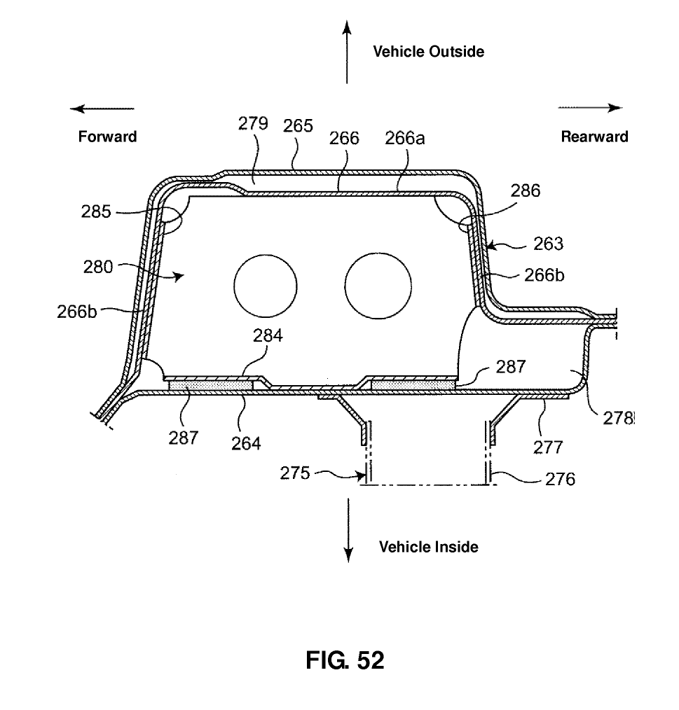

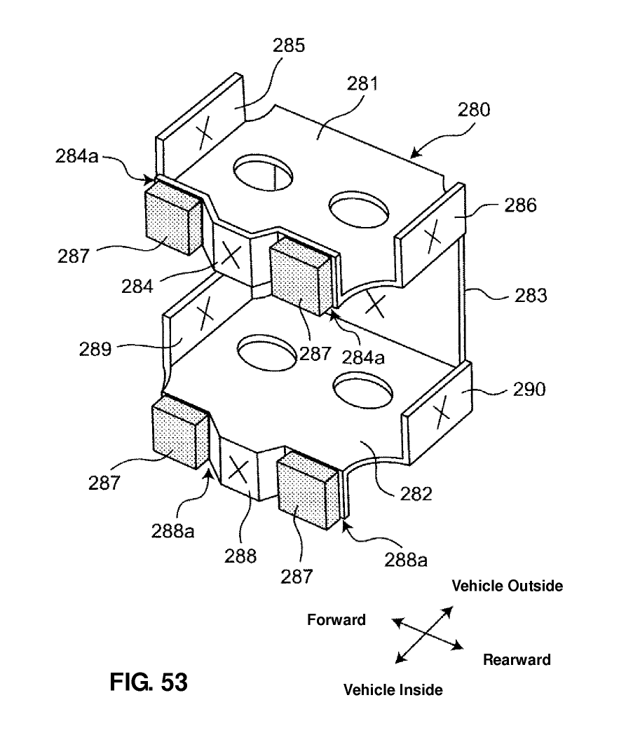

FIG. 49 is a view showing a side portion of a front side of the vehicle body to which a vehicle-body structure of a vehicle according to a twelfth embodiment of the present invention is applied, FIG. 50 is an elevational view of a major part of FIG. 49, when viewed along an arrow Y50, FIG. 51 is a sectional view taken along line Y51-Y51 of FIG. 50, FIG. 52 is a sectional view taken along line Y52-Y52 of FIG. 50, and FIG. 53 is a perspective view showing a bulkhead as the reinforcing member according to the twelfth embodiment of the present invention. Herein, FIG. 53 shows a state in which a damping member is attached to the bulkhead.

As shown in FIG. 49, there are provided, as members constituting the side portion of the vehicle body to which the vehicle-body structure according to the twelfth embodiment of the present invention is applied, a roof rail 261 which extends in the vehicle longitudinal direction at an upper portion of the vehicle body, a front pillar 262 which extends forward from a front end portion of the roof rail 261, a hinge pillar 263 which extends downward from a front end portion of the front pillar 262 and supports a front door (not illustrated), a side sill 267 which extends in the vehicle longitudinal direction at a lower portion of the vehicle body and is joined to the hinge pillar 236, and a center pillar 270 which extends vertically between a front door opening portion 268 and a rear door opening portion 269 and is joined to the roof rail 261 and the side sill 267.

The hinge pillar 263 is provided at a side portion of the vehicle body. A cylindrical instrument panel member 275 which extends in the vehicle width direction inside an instrument panel (not illustrated) is attached to the hinge pillar at its outside end.

This hinge pillar 263 comprises, as shown in FIG. 52, a hinge pillar inner 264 which forms a vehicle-body inside of the roof rail 263, a hinge pillar outer 265 which forms a vehicle-body outside of the roof rail 263, and a hinge pillar reinforcement 266 which is arranged between the hinge pillar inner 264 and the hinge pillar outer 265.

The hinge pillar inner 264 is formed to protrude toward the vehicle inside, and the hinge pillar reinforcement 266 and the hinge pillar outer 265 are respectively formed to protrude toward the vehicle outside. Respective front and rear end portions of these members 264, 265, 266 are joined together.

Thus, a closed-section portion 278 of the hinge pillar 263 is formed by the hinge pillar inner 264 and the hinge pillar reinforcement 266, and a closed-section portion 279 of the hinge pillar 263 is formed by the hinge pillar outer 265 and the hinge pillar reinforcement 266.

The instrument panel member 275 joined to the hinge pillar 263 comprises a cylindrical beam member 276 which extends in the vehicle width direction and an instrument-panel-member attaching member 277 which is fixed to one end of the beam member 276 and joined to the hinge pillar inner 264. The instrument panel member 275 is attached to an upper side of the hinge pillar inner 264. Herein, the hinge pillar inner 264 and the instrument-panel-member attaching member 276 may be joined together by bolt fastening with bolt and nut.

According to the present embodiment, a bulkhead 280 as the reinforcing member is provided in the closed-section portion 278 formed by the hinge pillar inner 264 and the hinge pillar reinforcement 266 of the hinge pillar 263 at a specified position on the inner face of the hinge pillar inner 264 which is located in the vicinity of a portion where the instrument panel member 275 is joined to the hinge pillar inner 264.

As shown in FIG. 53, the bulkhead 280 comprises first and second partition face portions 281, 282 as a partition wall portion which partitions the closed-section portion 278 and a connection portion 283 which interconnects respective vehicle-outside end portions of the first and second partition face portions 281, 282 vertically. The bulkhead 280 is formed to have a U-shaped section as shown in FIG. 51.

Further, the bulkhead 280 comprises a first flange portion 284 which is provided at a vehicle-inside side portion of the first partition face portion 281 and extends upward, a second flange portion 285 which is provided at a forward side portion of the first partition face portion 281 and extends upward, a third flange portion 286 which is provided at a rearward side portion of the first partition face portion 281 and extends upward, a fourth flange portion 288 which is provided at a vehicle-inside side portion of the second partition face portion 282 and extends downward, a fifth flange portion 289 which is provided at a forward side portion of the second partition face portion 282 and extends upward, and a sixth flange portion 290 which is provided at a rearward side portion of the second partition face portion 282 and extends upward. Seat portions 284a, 288a are formed at the first flange portion 284 and the fourth flange portion 288 respectively in a recess shape so as to accommodate viscoelastic members 287 therein, which will be described specifically.

The connection portion 283 of the bulkhead 280 is joined to an upper face portion 266a of the hinge pillar reinforcement 266 which protrudes by spot welding, the second and fifth flange portions 285, 289 of the bulkhead 280 are joined to a forward side face portion 266b of the hinge pillar reinforcement 266 which protrudes by spot welding. Further, the third and sixth flange portions 286, 290 of the bulkhead 280 is joined to a rearward side face portion 266b of the hinge pillar reinforcement 266 which protrudes by spot welding.

Further, the first flange portion 284 of the bulkhead 280 is joined to the hinge pillar inner 264 by spot welding, and the viscoelastic members 287 as the vibration damping member which are placed and adhere onto the seat portions 284a of the first flange portion 284 are made adhere to the hinge pillar inner 264. Thus, the first flange portion 254 is joined to the hinge pillar inner 264 via the viscoelastic members 287.

Further, the second flange portion 288 of the bulkhead 280 is joined to the hinge pillar inner 264 by spot welding, and the viscoelastic members 287 as the vibration damping members which are placed and adhere onto the seat portions 288a of the second flange portion 288 are made adhere to the hinge pillar inner 264. Thus, the second flange portion 287 is joined to the hinge pillar inner 264 via the viscoelastic members 287.

Herein, the sheet-shaped viscoelastic members 257 are made adhere to the seat portions 284a, 288a of the first and fourth flange portions 284, 288 of the bulkhead 280, the bulkhead 280 is arranged in the hinge pillar reinforcement 266, corresponding to a portion where the instrument panel member 275 is provided, and the connection portion 283, the second flange portion 285, the third flange portion 286, the fifth flange portion 289, and the sixth flange portion 290 are respectively joined to the hinge pillar reinforcement 266. Then, respective front and rear end portions of the hinge pillar inner 264, the hinge pillar reinforcement 266 and the hinge pillar outer 265 are joined together, and the first and fourth flange portions 284, 288 are joined to the hinge pillar inner 264. Thus, the bulkhead 280 is attached in the closed-section portion 277. After this, the instrument panel member 275 is joined to the vehicle inside of the hinge pillar inner 264.

In a state in which the bulkhead 280 is provided in the closed-section portion 277 formed by the hinge pillar inner 264 and the hinge pillar reinforcement 266, the spot-welding joint portions of the bulkhead 280 to the frame comprised of the hinge pillar inner 264 and the hinge pillar reinforcement 266 constitute the rigid joint portions. Meanwhile, the joint portion via the viscoelastic member constitutes the flexible joint portion. In FIG. 53, the spot-welding portions of the bulkhead 280 are shown by x marks.

According to the vehicle-body structure of a vehicle according to the twelfth embodiment of the present invention, since the bulkhead 280 is rigidly joined to the hinge pillar inner 264 and the hinge pillar reinforcement 266 and flexibly joined to the hinge pillar inner 264 via the viscoelastic members 287, the bulkhead 280 can be firmly joined to the frame formed by the hinge pillar inner 264 and the hinge pillar reinforcement 266 with the rigid joint portions, thereby providing the rigid-improvement effect, and the vibration of the above-described frame can be reduced with the flexible joint portion, thereby restraining the vibration transmission to passengers in the vehicle compartment.

Further, since the joint portions of the frame comprised of the hinge pillar inner 264 and the hinge pillar reinforcement 266 to the bulkhead 280 are provided at the specified position on the inner face of the frame which are located in the vicinity of the portions where the instrument panel member 275 is joined to the frame, vibrations inputted to the frame from the instrument panel member 275 can be reduced effectively.

Moreover, the bulkhead 280 is comprised of the two sheet-shaped partition face portions 281, 282 which partition the closed-section portion 278 and the connection portion 283 which interconnects these partition face portions 281, 282, the rigidity-improvement effect by the bulkhead 280 can extend over a properly-wide area of the frame forming the closed-section portion 278. Further, the number of parts can be reduced by half, compared with a case in which two separate bulkheads are arranged at two adjacent positions in the closed-section portion 278, thereby improving efficiencies of parts management and assembling works.

While the bulkhead as the reinforcing member which is provided in the closed-section portion of the frame is formed by the two vehicle-body forming members in the above-described embodiments, it may be provided in the closed-section portion of the frame which is formed by a single or three or more vehicle-body forming members.

Further, while the frame which is comprised of the vehicle-body forming member forming the closed-section portion and the bulkhead are rigidly joined together by spot welding in the above-described embodiments, they may be rigidly joined by bolt-nut fastening in place of spot welding.

Herein, while the sheet-shaped viscoelastic member which is relatively thick is used as the damping member and adheres to the bulkhead in the above-described embodiments, a relatively thin viscoelastic member may be used, and also a liquid-type of viscoelastic member may be applied onto the bulkhead.

The present invention should not be limited to the above-described embodiments, and any other further modifications or improvements may be applied within the scope of a sprit of the present invention.

What is claimed is:

1. A vehicle-body structure of a vehicle, comprising:
a frame comprised of at least one vehicle-body forming member forming a closed-section portion;
a reinforcing member provided in the closed-section portion of said frame and joined to the frame; and
another vehicle-body forming member joined to an outer face of said frame, which is different from said at least one vehicle-body forming member,
wherein a joint portion of said frame and said reinforcing member includes a rigid joint portion where the frame and the reinforcing member are joined with a direct contact thereof and a flexible joint portion where the frame and the reinforcing member are joined via a damping member provided therebetween, and said joint portion is provided at a specified position on an inner face of the frame which is located in the vicinity of a portion where said another vehicle-body forming member is joined to the frame.

2. The vehicle-body structure of a vehicle of claim 1, wherein said damping member is a viscoelastic member having physical properties which fall within a range enclosed by six coordinate points: (1, 0.4), (2, 0.2), (10, 0.1), (1000, 0.1), (2000, 0.2) and (10000, 0.4) in an X-Y coordinate system with X axis of the storage modulus and Y axis of the loss factor, or a range exceeding the loss factor of 0.4.

3. The vehicle-body structure of a vehicle of claim 1, wherein said reinforcing member is a bulkhead having at least one flange portion provided at a periphery thereof, and said joint portion is provided at said flange portion.

4. The vehicle-body structure of a vehicle of claim 2, wherein said reinforcing member is a bulkhead having at least one flange portion provided at a periphery thereof, and said joint portion is provided at said flange portion.

5. The vehicle-body structure of a vehicle of claim 4, wherein said bulkhead comprises two sheets of partition face portion which partition said closed-section portion of the frame and a connection portion which connects said two sheets of partition face portion.

6. The vehicle-body structure of a vehicle of claim 4, wherein said rigid joint portion and said flexible joint portion are provided at one flange portion of said bulkhead.

7. The vehicle-body structure of a vehicle of claim 5, wherein said rigid joint portion and said flexible joint portion are provided at one flange portion of said bulkhead.

8. The vehicle-body structure of a vehicle of claim 1, wherein said closed-section portion of the frame is comprised of two vehicle-body forming members.

9. A manufacturing method of a vehicle-body structure of a vehicle which comprises a frame comprised of at least one vehicle-body forming member forming a closed-section portion, a reinforcing member provided in the closed-section portion of the frame and joined to the frame, and another vehicle-body forming member joined to an outer face of the frame, which is different from said at least one vehicle-body forming member, the method comprising a step of joining the frame and the reinforcing member at a specified position on an inner face of the frame which is located in the vicinity of a portion where said another vehicle-body forming member is joined to the frame,
wherein said joining step includes a rigid joining step of joining the frame and the reinforcing member with a direct contact thereof and a flexible joining step of joining the frame and the reinforcing member via a damping member provided therebetween.
